(19) United States
(12) Patent Application Publication
(10) Pub. No.: US 2008/0282160 A1
(43) Pub. Date: Nov. 13, 2008

(54) Designated screen capturing and automatic image exporting

(76) Inventors: James Ian Tonnison, Oneida, NY (US); Wenxuan Tonnison, Oneida, NY (US)

Correspondence Address: BOND, SCHOENECK & KING, PLLC, ONE LINCOLN CENTER, SYRACUSE, NY, 13202-1355, US

(21) Appl. No.: 11/784,221

(22) Filed: Apr. 6, 2007

(51) Int. Cl. G06F 3/048

(52) U.S. Cl. 715/704; 715/700; 715/785

(57) ABSTRACT

A method of continuously capturing a plurality of designated screens of at least one targeted computer program or computer system, and automatically exporting the screen images into at least one destination file for documentation purpose is disclosed. The method includes intercepting keystrokes, mouse-clicks, and/or voice commands to capture a plurality of designated screens, or intercepting and logging keystrokes, mouse-clicks, and/or voice commands for replaying the actions of capturing a plurality of similar screens in a future time frame, and automatically exporting captured screen images to at least one destination file via an export utility tool.

### BACKGROUND OF THE INVENTION

1. Field of Invention

The present art relates to continuously capturing a plurality of screens that could be non-sequential on a display monitor, in at least one targeted computer program or computer system, in response to user keystrokes, mouse-clicks, voice commands, or recorded instructions, and automatically exporting the captured screen images to at least one destination file for documentation purposes.

2. Description of Related Art

There are many different screen capturing techniques that currently exist. The conventional techniques for screen capturing are focusing on the following areas:

A. Capturing dynamic sequential screens of a computer system whereby the contents of a computer system change constantly. A dynamic screen means the contents of the screen are changed constantly or in real time by the computer system. For example, capturing Trading System dynamic screens whereby transactions are posted on a computer screen instantaneously, such that sequential screens of system can be automatically captured by setting the capturing time interval. The captured sequential screens can be displayed or played back like a video showing the content changes of the screen. However, this type of prior art does not address non-dynamic and non-sequential multiple screen capturing of one or more computer programs or systems.

B. Capturing, processing, and archiving a series of user interactive sequential events via a Transaction Recording System, which is integrated into the to-be-captured computer system, such as a stock trading system. The captured information is indexed and stored for future access either on a terminal device or an accessible remote server device. The capturing process is activated by an initiation signal or a termination signal from a remote server. However, this prior art does not address capturing non-sequential event screen shots of at least one targeted computer program or system. The prior art limits itself to activating a screen capturing process by building a Transaction Recording System in the targeted application whereby its sequential screens are to be captured.

C. Capturing images of multiple windows on a computer screen. Such windows can be either static windows or dynamic windows. A static window means the content of the window is not changed constantly or instantaneously. For static windows, a single screen shot of all windows displayed on the same screen can be captured or only the active window (the window with the current focus) of the multiple windows displayed on the same screen is captured. Certain capturing software can capture multiple dynamic windows on the same screen at the same time. However, these capturing softwares are limited to capturing only one or multiple windows on a single screen, and they do not address continuous capturing of a plurality of non-dynamic and non-sequential computer screens of at least one computer program or system.

D. Capturing images of a sequential operation on a computer system include the movement of curser to produce a video for presentation or training purposes. However, this type of prior art does not address non-dynamic and non-sequential multiple screens capturing of at least one computer program or system.

E. Capturing a single screen shot of a computer application, such as a Microsoft Office or a web page displayed by a browser, by allowing automatic scroll down to capture contents outside of screen display area. However, this category of software is limited to capturing a single page, although some portion is outside of initial display, of specially modified computer application, and replacing the prior image captured with the new image captured in the display region of the capturing program. They do not automatically export all images to at least one destination file. They do not address capturing a plurality of non-sequential computer screens of one or more targeted computer programs or systems.

F. Maintaining duplicate copies of at least a portion of a computer display screen at two or more physically remote locations and, more particularly, to efficiently communicate changes on a display screen to one or more other display screens. Obviously, this prior is addressing storage and communicating change of a computer display screen among different locations. It does not address non-dynamic and non-sequential multiple screens capturing of one or more targeted computer programs or systems.

G. Capturing of screen images to facilitate an end-user's testing of a software application by identifying a critical event and the screen activities for a period of time prior to the critical event is captured. Obviously, the purpose of this prior art is to facilitate end-user testing, and it is not related to non-dynamic and non-sequential multiple screens capturing of one or more targeted computer programs or systems.

H. Capturing a screen image of a host system for transmission over a computer network for remote viewing and remote system management via a network management card. Obviously, this prior art is addressing screen image transmission enabled by hardware, and it's not related to non-dynamic and non-sequential multiple screens capturing of one or more targeted computer programs or systems.

I. Capturing a screen shot of a shared application window and determining a position and size of the shared application window by monitoring function calls made by the application for data conferencing. Data conferencing systems allow computer users at different locations to communicate via a computer network and share applications stored and/or executed on one of the user's computers. However, the purpose of the prior art is to capture a screen of a shared application window for data conferencing, and it does not address the capturing of non-dynamic and non-sequential screens of at least one computer application or system.

J. Inserting into a document at least one screen image of a computer software application including inserting a macro in the document of the screen image, the macro including instructions for navigating the computer software application to the screen image and for capturing the screen image for building technical documents of different human languages. Obviously, this prior art is related to capturing screen images for building technical documents of different human languages of a computer program by inserting a macro. It does not address the capturing of non-dynamic and non-sequential screens of at least one computer application and system.

K. There are other conventional screen capture techniques, such as utilizing screen capturing to monitor computer usage; transmitting video data captured from computer screens to a remote computer system; capturing screen displays from a host computer for display at a remote terminal; techniques for placing sequential or individual labels in an electronic image, and as objects in the image are respectively identified, labels with parameters are automatically generated and then placed upon or near the identified objects; browser periodically captures screen images having multimedia objects at configurable time intervals or when there is a change in content of a screen image; motion estimation and compensation to improve screen capture video for training or remote instruction purposes, and the like. Obviously, all these prior arts do not address capturing of non-dynamic and non-sequential screens of at least one computer application or system.

In summary, the prior arts do not address Designated Screen Capturing (DSC) of non-dynamic and non-sequential screens of at least one targeted computer application or system for documentation purposes. Currently, capturing a plurality of screens in one or more targeted computer programs or systems with non-dynamic screens is involved with the tedious manual work of opening up a destination file, returning back to the targeted computer program screen that needs to be captured, pressing a button, e.g., the “Print Screen” button, on the keyboard, returning to the destination file, clicking “Paste” to paste the screen shot in the destination file, returning back to the targeted program, pressing a “Page Down” key, a “Next Page” button or others to arrive at the next desired screen, pressing the “Print Screen” button on the keyboard, returning back to the destination file, paste the 2nd screen shot below the first one, and returning back to the targeted computer program or other targeted computer programs to repeat the similar process again and again to capture a plurality of non-sequential screens.

Such tedious manual work hinders most companies from keeping source documents in a digital format. Although most people believe that our society is in an information era, thanks to the invention of computers, no one can deny the fact that computerization has not significantly reduced our reliance on paper, and that there is still a long way to go for our society to be a real paperless society.

Some reasons that computer systems did not help us to significantly reduce paper consumption are:

Most computer programs are proprietary systems, be it Oracle System, PeopleSoft, SAP, JDE, etc., that do not support designated screen capturing. For most companies, multiple computer programs must be utilized in order to fulfill each company's daily operation and management. There is no uniform way of obtaining a subset of information from different systems in a digital format. As a result, sharing, manipulating, reviewing or analyzing internal data stored or produced by different computer programs are normally carried out in paper format.

Capturing digital data produced by different proprietary computer programs or systems is a highly manual process as depicted above. There is no software to reduce the manual aspect of capturing screen shots, and to automate the continuous screen capturing of digital data screens produced by different proprietary computer programs or computer systems, so that digital copy of the information can be maintained, rather than in hard copy format.

Most companies utilize different computer programs or systems to facilitate automatic information flow within their respective organization, and the automatic process normally stops at a company level. But in reality, the information flow process does not just stop at the company level—an ending step of the information flow of one company can be the beginning step of the information flow of another company. There is no or limited software to enable this continuous automatic information flow, especially if the information is not in large quantity that is normally handled by Electronic Data Interchange (EDI). As a result, most companies are relying on hard copy documents to complete the information flow process. For example, it is not cost effective for companies to establish an EDI system with various hotels and travel services agencies for employee business travel data. So, most companies require their employees to supply hard copy hotel receipts and other receipts generated by other entities' computer systems for expense processing. With designated screen capturing technique, such receipts can be screen captured and provided in a digital format on demand.

### SUMMARY OF THE INVENTION

The purpose of the invention is to enable easy capturing of designated screen shots of a plurality of screens of any computer program or system by a Designated Screen Capturing (DSC) program. The advantages of the invention are to reduce the manual process of capturing a plurality of screen shots of any computer program or computer system, improve the efficiency of capturing a plurality of screen shots, facilitate the centralization of needed information, and additionally, reduce our heavy reliance on paper.

During the past few years, government regulations have been strengthened to require corporations to maintain more documentation and evidence. This invention allows corporations to retain their data and evidence obtained from their proprietary computer systems or their business partners' proprietary computer systems in a digital format, rather than in hard copies, to comply with government regulations.

The invention allows a company to provide digital documents/files of the information pulled from their proprietary computer programs/systems or their business partners' proprietary computer programs/systems to other external agencies, such as examiners or auditors. This enables examiners and auditors to maintain supporting or source documents in digital format, eliminates the hassle to carry or transport hardcopy supporting or source documents. It also enables reviewers to examine those documents without the need to wait for the shipping of the documents; as well as eliminating geographical restrictions.

Also, the invention not only helps to eliminate the manpower and resources needed for shipping and archiving hard copy documents, but also makes it easier to locate needed documents without geographical or physical constraints, and effectively resolves over-due or missing supporting/source document issues occur during the shipping and archiving process.

The invention enables a company to share, review, manipulate, and analyze internal data stored or produced in its different proprietary programs or systems by using the digital screen prints captured by the designated screen capture technique, rather than using a paper format.

As a result, the invention helps reduce the tedious manual process of capturing a plurality of screens, improves the efficiency of data manipulation and information flow inside and outside of a company. As a side effect, it helps save resources, such as manpower and trees, reduces landfill space requirements, and enhances environmental protection.

A designated screen capturing process is proposed to facilitate the provisioning of capturing a plurality of screen shots of at least one targeted computer program or computer system. The process enables a user to easily capture a plurality of screen shots using a minimum number of keystrokes, mouse-clicks, and/or voice commands. In one embodiment, a user presses at least one hotkey and/or mouse-click to activate DSC program. In another embodiment, at least one user-spoken voice command, or the combination of voice command and keystroke/mouse-click, activates DSC program. Once activated, the program automatically captures the current screen image. And in response to pressing other hotkeys, such as a “Page Down”, “Scroll Down”, or “Scroll Right”, etc., or in response to user voice commands, such as saying “Page Down”, “Scroll Down”, or “Scroll Right”, etc., the program automatically captures the next screen displayed, and automatically exports all captured screen images into at least one destination file. There is no going back and forth between the to-be-captured program screens and the destination file containing captured images.

The capturing action can be turned on or off by the user pressing at least one hotkey or mouse-click, or giving at least one voice command, such as “Capture Off”. This enables non-sequential displaced screens to be captured from at least one targeted computer application. The invention allows a user to capture a plurality of screens of different sections of at least one computer program or computer system. A user presses a button(s) on the current computer program or uses a voice command(s) to arrive at the desired page, and then the user activates DSC program by pressing a hotkey(s) or making a mouse-click(s), or by using a voice command(s) to capture the current screen. The user can then turn off the capturing. And then, he presses one or more buttons, keystrokes, mouse-clicks or uses one or more voice commands to arrive at the second desired screen, which could be in another targeted computer system. Next, the user presses a hotkey(s) or makes a mouse-click(s), or uses a voice command(s) to make a snapshot of the specified screen. This process proceeds until all desired screens are captured, which are automatically exported to the destination file or to DSC display area.

DSC program can also be built to capture each screen only upon certain keystroke(s)/mouse-click(s) or voice command(s) for screen capturing. In this way, the user activates DSC screen capturing each time a desired screen is to be captured, thus, eliminating the step to temporarily turn off DSC screen capturing in order to navigate to another desired screen(s). All images captured are automatically exported to at least one destination file.

In another embodiment of the invention, the designated screen capture program allows sequential recording of keystrokes, mouse-clicks and/or voice commands entered by a user for the first time when capturing a plurality of screen shots of at least one computer program or system. This knowledge gathering technology can be used to automatically generate continuous screen shots of the above mentioned computer program or system after the initial input, thus eliminating the tedious manual capturing process. The recorded log can be converted to a template that can be used to enable automatic screen capturing of similar accounts, items, and forms of the targeted computer program.

The automatic screen shot generating technology could be used to allow routine batch processing or on demand batch processing to generate continuous screen shots, especially if there are large numbers of screen shots. As a result, the technology can eliminate a tedious and time-consuming process.

The invention also tracks the exact version of the targeted computer programs, the location of the programs within a specific computer system, and other data, so as to link captured key sequences with specific programs.

Also, the invention consists of the idea of communicating with a proprietary computer program to recognize the scroll up/down and scroll right/left commands, and to automatically produce continuous screen captures by pressing a built-in button(s) in the targeted computer program or by pressing a hotkey(s) or mouse-click(s), or using a voice command(s) recognized by DSC program. The built-in function allows a user to press a designated screen capture button(s) in the targeted computer program, which triggers the automatic generation of a continuous screen capturing digital file. As for pressing a hotkey or mouse-click, once the hotkey or mouse-click is pressed, DSC program automatically activates the designated screen shot feature, and automatically scrolls up, down, right, or left the window to capture the entire screen including areas outside the computer display region. The same actions are performed when DSC program receives user voice commands.

The user then navigates to other screens of the targeted computer system, pressing a built-in button(s) in the targeted computer program or by pressing a hotkey(s) or mouse-click(s), or by using a voice command(s) recognized by DSC program to capture the desired screens. Such capturing proceeds until all desired pages are captured. All the images are automatically exported to at least one destination file.

This embodiment of the invention further comprises a designated capturing on/off button, keystroke, mouse-click or voice command to allow capturing of non-sequential displayed screens as well as allowing a user to select a plurality of items to be captured in at least one targeted computer program without physically clicking each item to display it on the screen before capturing.

### BRIEF DESCRIPTION OF THE DRAWINGS

FIG. 1 is a block diagram depicting a computer system in which the present method, systems and program may be implemented.

FIG. 2 is a block diagram depicting major components in computer memory for enabling Designated Screen Capturing (DSC) of non-sequential screens of a targeted computer application(s).

FIG. 3 is a flow diagram depicting screen capturing of a plurality of non-sequential screens in response to user interaction with at least one targeted computer application.

FIG. 4 is a flow diagram depicting how keystroke/mouse-click intercepting works for designated screen capturing.

FIG. 5 is a flow diagram depicting how keystroke and mouse-click logging works for designated screen capturing.

FIG. 6 is a flow diagram depicting how keystroke and mouse-click replaying works for designated screen capturing.

FIG. 7a is a flow diagram depicting the process of indexing captured screens with their respective attributes, including security features

FIG. 7b is a flow diagram depicting the process of modifying a previously saved image file.

FIG. 8 is a flow diagram depicting how bitmaps of a plurality of screens are exported to a destination file for designated screen capturing.

FIG. 9 is a flow diagram of how a designated screen capturing keystroke/mouse-click template can be used by a user to generate a plurality of screen shots of similar accounts, tracking tickets, and the like, in targeted computer program(s) or system(s).

FIG. 10 is a flow diagram of how target computer program incorporates or interfaces with DSC to allow selection of non-sequential screens and producing a plurality of screen shots.

FIG. 11 is a flow diagram of how DSC allows selection of items in a targeted computer program or system to produce a plurality of screen shots without the need for a user to open up the items.

FIG. 12 is an exemplary illustration of a flow diagram for designated screen captures of at least one targeted computer programs or computer systems upon user voice commands.

FIG. 13 is a flow diagram depicting how DSC batch processing works, including DSC jobs be submitted as batch processing jobs to a job scheduler to automatically generate a plurality of screen shots.

FIG. 14 is an exemplary illustration of DSC GUI interface.

FIG. 15 to FIG. 19 are exemplary illustrations of how DSC is used to capture a plurality of screens of SAP System.

FIG. 20 to FIG. 23 are exemplary illustrations of DSC is used to capture a plurality of screens of multiple computer programs or systems.

FIG. 24 and FIG. 25 are exemplary illustrations of a designated screen capturing keystroke/mouse-click template that is used by a user to generate a plurality of screen shots of similar accounts and tracking tickets in targeted software.

FIG. 26 to 28 are exemplary illustrations of how target computer program incorporates DSC to allow selection of non-sequential screens and producing a plurality of screen shots.

FIG. 29 and FIG. 30 are exemplary illustrations of a user selecting items in a targeted computer program or system and utilizing DSC to producing a plurality of screen shots without the need for a user to open up the items.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention.

Parts of the description will be presented in terms of operations performed by a processor based device, using terms such as data, tables, requesting, selecting, supplementing, displaying, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical and electrical components of the processor based device; and the term processor includes microprocessors, micro-controllers, digital signal processors, and the like, that are standalone, adjunct or embedded.

Various operations will be described as multiple discrete steps in turn, in a manner that is most helpful in understanding the present invention; however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

Other features of the illustrated embodiments will be apparent to the reader from the foregoing and the appended claims, and as the detailed description and discussion in conjunction with the accompanying drawings.

While the invention is described and illustrated here in the context of a limited number of embodiments, the invention may be embodied in many forms without departing from the spirit of the essential characteristics of the invention. The illustrated and described embodiments, including what is described in the abstract of the disclosure document, are therefore to be considered in all respects as illustrative and not restrictive. The scope of the invention is indicated by the appended claims rather than by the forgoing description, and all changes, which come within the meaning and range of equivalency of the claims are intended to be embraced therein.

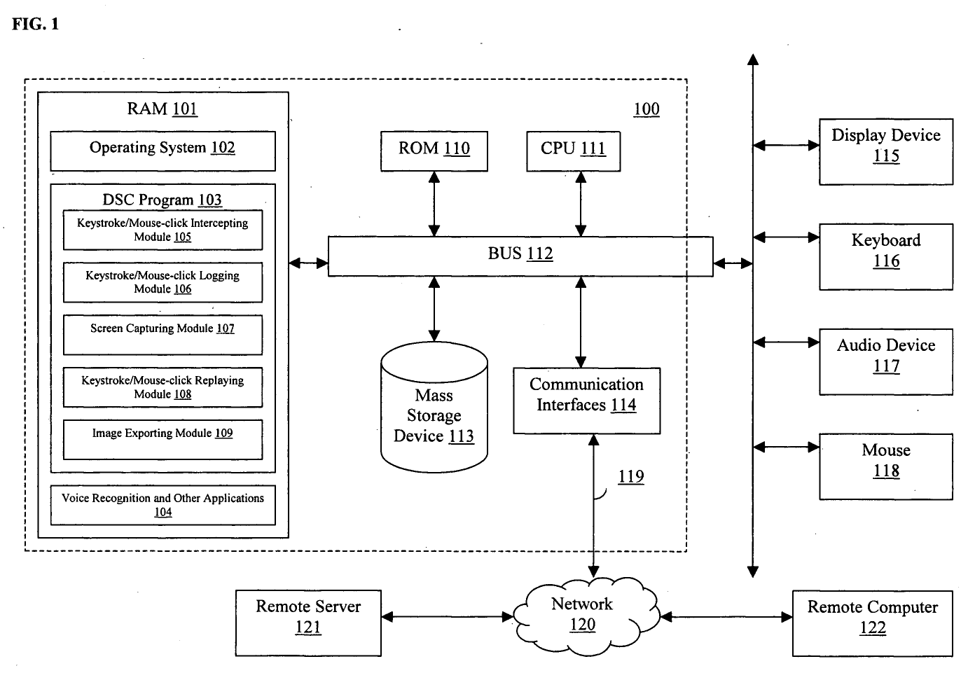

Now referring to the drawings and in particular to FIG. 1, which depicts one embodiment of a system through which the present method, system, and program may be implemented. The present invention may be executed in a variety of systems, including a variety of computing systems and electronic devices.

Computer system 100 includes Random Access Memory (RAM) 101 and Read Only Memory (ROM) 110, a Central Processing Unit (CPU) 111, and a system Bus 112 or other communication device for communicating information within computer system 100. A number of program modules may be stored in mass storage device 113 and RAM 101, said RAM 101 includes an Operating System 102, Designated Screen Capture (DSC) Application 103, as well as Voice Recognition and Other Application Programs 104. DSC 103 includes Keystroke/Mouse-click Intercepting Module 105, Keystroke/Mouse-click Logging Module 106, Screen Capturing Module 107, Keystroke/Mouse-click Replaying Module 108, and Image Exporting Module 109.

The Voice Recognition Program is depicted as an external program of DSC Program 103, but one should understand that it could also be an internal module of DSC, and that all the other modules of DSC can be activated by voice command(s).

CPU 111 may be a general-purpose processor that, during normal operation, processes data under the control of operating system and application software accessible from a dynamic storage device, RAM 101, and a static storage device, ROM 110.

Bus 112 preferably includes low latency and high latency paths that are connected by bridges and adapters and controlled within computer system 100 by multiple bus controllers.

The present invention may be provided on a machine-readable medium that includes any medium that participates in providing instructions to Central Processing Unit 111 or other components of computer system 100 for execution.

A machine-readable medium may take any form including, but not limited to, volatile media, transmission media, and non-volatile media. Volatile media include dynamic memory such as RAM 101. Transmission media include coaxial cables, copper wire or fiber optics, including the wires that comprise Bus 112.

The computer system 100 further includes Mass Storage Device 113 and Communication Interfaces 114. Mass Storage Device 113 is an example of a non-volatile medium, which is depicted as an internal component of computer system 100, but one should understand that it could also be an external device.

Communication interfaces 114 provide two-way data communications connected to Network Link 119 that may be connected, for example, to a Network 120, such as a Local Area Network (LAN), Wide Area Network (WAN), or directly to an Internet Service Provider (ISP). In particular, Network Link 119 may provide wired and/or wireless network communication to one or more networks.

In a networked environment, program modules depicted relative to the computer system 100, or portions thereof, may be stored and transferred from a Remote Server 121. Data from computer system 100 may be stored or tracked on such a Remote Server 121 and there can be more than one such server. It will be appreciated that the network connections shown are exemplary and other means of establishing a communication link between the computers may be used.

The computer system 100 further includes multiple peripheral components that facilitate communication. These peripheral components are connected to multiple controllers, adaptors, and extension slots that are connected to one of the multiple levels of Bus 112. In this exemplary diagram, a Display Device 115 is connectively enabled on Bus 112 for providing visual, tactile or other graphical representation formats. A mouse 118 is connectively enabled on Bus 112 for controlling the location of a pointer within Display Device 115. A Keyboard 116 is connectively enabled on Bus 112 as an interface for user inputs to computer system 100. The keyboard can be any type, such as dome-switch keyboard, capacitive keyboard, buckling-spring keyboard, laser keyboard, membrane keyboard, etc. An Audio Device 117 is connectively enabled on Bus 112 for controlling audio inputs and outputs. In alternative embodiments of the present invention, additional input and output peripheral components may be added.

Other input devices (not shown) may include a microphone, joystick, game pad, satellite dish, scanner, or the like. In addition to the Display Device 115, computers typically include other peripheral output devices (not shown), such as speakers, printers, or the like. Other devices may include handhold devices, such as a PDA, cell phone or blackberry, etc.

The computer system 100 may operate in a networked environment using connections to one or more remote computers, such as a Remote Computer 122. The Remote Computer 122 may be a router, a peer device or other common network node, and typically includes many or all of the elements described relative to the computer system 100. DSC may reside on a client PC or on a remote server and the storage of the captured screens can be on a client PC or on a remote server.

Those skilled in the art will appreciate that the hardware depicted in FIG. 1 may vary. Furthermore, those skilled in the art will appreciate that the depicted example is not meant to imply architectural limitations with respect to the present invention.

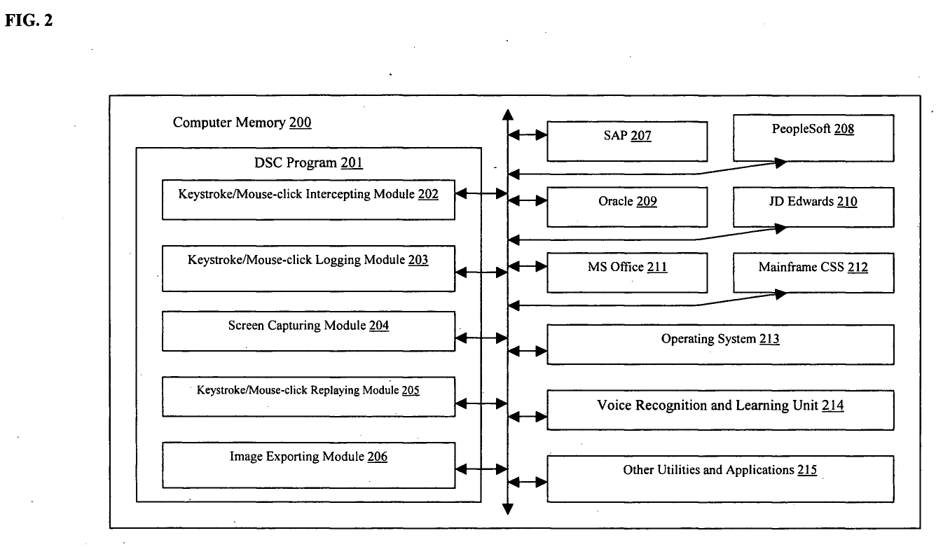

Referring to FIG. 2 therein is presented an exemplary diagrammatic representation of different components in computer memory and their connectivity according to the present invention. As represented in FIG. 2, Computer Memory 200 includes Operating System 213 (such as UNIX, Windows or Linux, etc), a plurality of Proprietary Programs (such as SAP 207, PeopleSoft 208, Oracle 209, JD Edwards 210, MS Office 211 or Mainframe CSS 212), a Voice Recognition and Learning Unit 214, and Other Utilities and Applications 215. It should be noted that Voice Recognition and Learning Unit could be built into DSC, rather than an external program to DSC.

DSC Program 201 contains Keystroke/Mouse-click Intercepting Module 202, Keystroke/Mouse-click Logging Module 203, Screen Capturing Module 204, Keystroke/Mouse-click Replaying Module 205, and Image Exporting Module 206. It will be understood that there is no implied boundary between DSC Program 201 and each of the components of the present invention. They could be implemented as integral parts of DSC Program 201. It will be appreciated that these special functions could be independent of one another, and one could implement a subset of these functions, rather than all of them.

The function of the Keystroke/Mouse-click Intercepting Module 202 of an exemplary embodiment of the present invention is to intercept user keystrokes and mouse-clicks. The function of the keystroke/Mouse-click Logging Module 203 is to log user keystrokes and mouse-clicks. The function of the Screen Capturing Module 204 is to collect the current screen display and convert it into a bitmap or other intermediate format. The function of the Keystroke/Mouse-click Replaying Module 205 is to replay the sequence of the keystroke and/or mouse-clicks in the exact order recorded. The function of the Image Exporting Module 206 is to convert the intermediate format into an image stream that has graphic format acceptable to a destination file(s). The image stream is saved to the destination file(s) via an export utility tool. It should be noted to those skilled in the art that these functions can also be activated by voice command(s) or the combinations of keystroke(s)/mouse-click(s) and voice command(s).

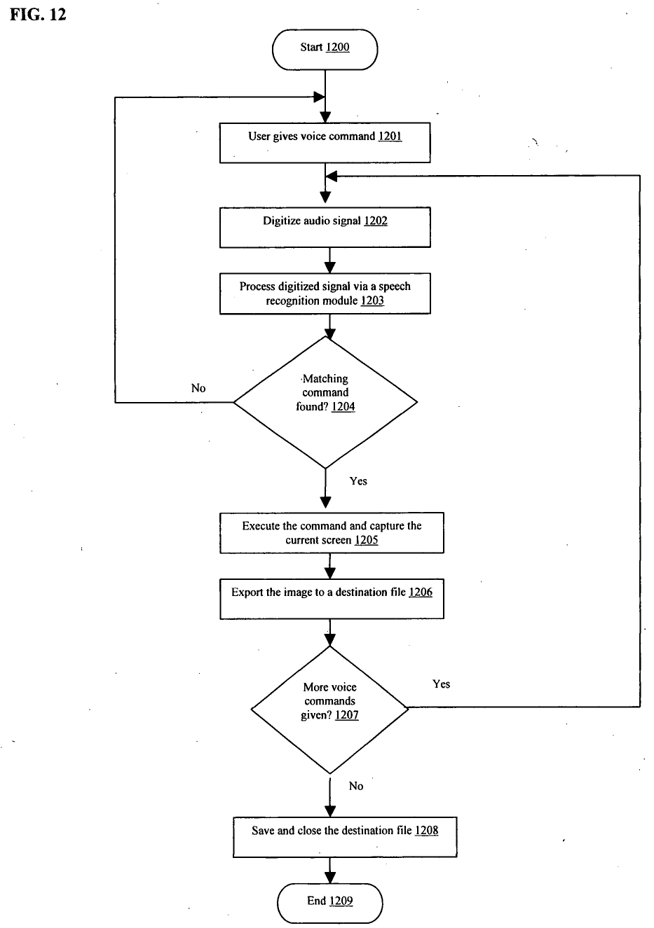

These modules of DSC program interact with other proprietary or targeted computer programs to produce a plurality of screen images of those programs. DSC program runs either in the background or with a display can be minimized on a computer. A picture taking sound can be generated by DSC each time a screen is captured. Also, DSC may have a voice recognition module to act upon a user's verbal commands for navigating to desired screens to capture them (see more detail in FIG. 12).

A number of logical components are involved in implementing the different modules within DSC program. These components can be configured to follow the client/server model, wherein the available computing power can be distributed and shared among the client workstations, which is well known to those skilled in the computer art.

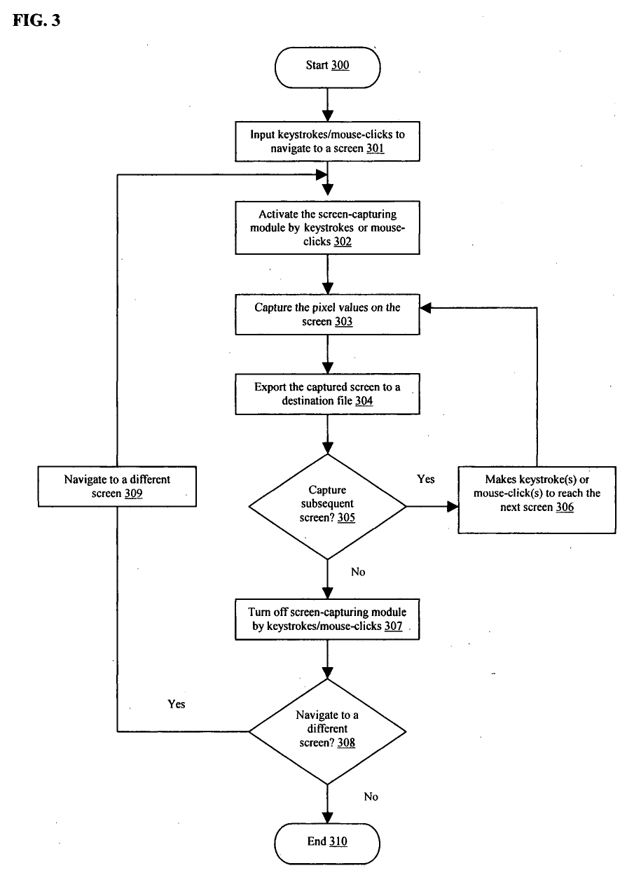

With reference to FIG. 3, therein is presented a high-level logic flowchart illustrating an exemplary process and program for screen capturing of a plurality of non-sequential screens in response to user interaction with at least one targeted computer application. The process of FIG. 3 is implemented in software language, such as C++, C#, Java, etc., and executed under an operating system such as MS Windows, Mac, Linux, UNIX, etc. in a computing device such as shown in FIG. 1. However, the capture application is not meant to be limited to implementations using the aforementioned languages and operating systems, but may be implemented using other languages and operating systems.

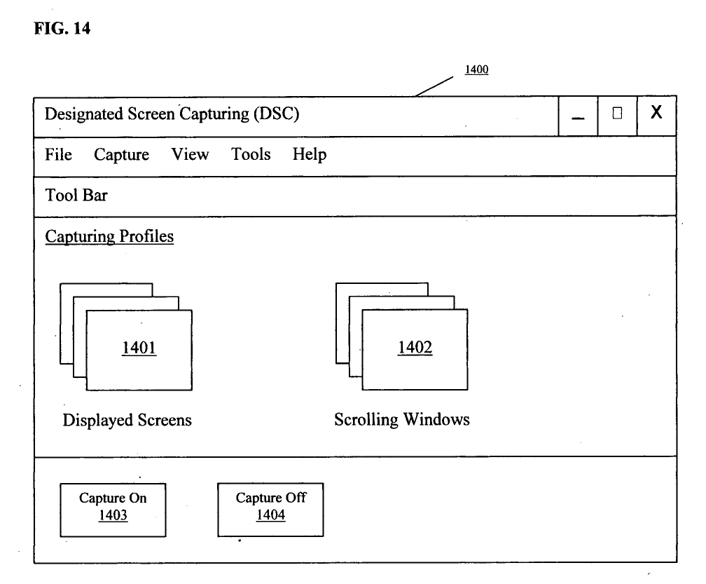

As indicated, the process starts at step 300 and thereafter proceeds to 301 whereby a user inputs keystroke and/or mouse-clicks to navigate to a screen of a targeted program or system to be captured. The user activates the screen-capturing module by keystroke(s) or mouse-click(s) as depicted at step 302. For example, it may be activated by such means as a user double clicking on a desktop icon. Upon this activation, DSC program automatically captures the pixel values on the screen as shown at step 303. This screen capture process may be initiated by a user pressing hotkey(s), mouse-click(s), or pressing a button on DSC user interface (see detail in FIGS. 14, 26, 27 and 28), etc. Screen captures may also be initiated by other programs or processes that automatically determine which screen to capture. The entire screen, certain windows or specified areas of the screen may be captured. There is an option here (not shown on the flowchart) for DSC to send a “picture taken sound” signal to an Audio Device to generate such a sound.

Next, the program exports the captured screen to a destination file at step 304. The program can request the user to input a destination file name or automatically generate a generic file name (e.g., image 1) for the captured screens. A determination is made at step 305 as to whether a subsequent screen should be captured. If yes, the user presses keystroke(s)/mouse-click(s) to reach subsequent screen (e.g., pressing page down or click next page) as indicated at step 306. The process then goes back to step 303 whereby DSC automatically captures the pixel values of the subsequent screen. Also, There is an option here (not shown on the flowchart) for DSC to send a “picture taken sound” signal to an Audio Device to generate such a sound. The captured subsequent screen is then exported to the same destination file, which now comprises more than one screen images at step 304. Such loop continues until the user decides no subsequent screens to be capture, at which point, the process continues to step 307 whereby the user temporarily turns off screen capturing module by keystroke(s) and/or mouse-click(s).

The destination file(s) may be any type of computer-generated document capable of containing captured screen shots; examples of destination documents are MS Word, Adobe PDF, JPEG, etc. As mentioned above, the destination document name and directory path may be specified by the user or assigned by DSC program. This document may be an existing document or a newly created one depending on the user's choice. Additionally, DSC application can have the capability to display the captured screen shots via a graphical user interface or by other means. In other words, destination document display can be part of DSC application.

At this point, another determination is made by the user as to whether he needs to navigate to a different screen in the same targeted computer program or a different one, which is depicted at step 308. If yes, the user navigates to a desired screen, which may take him multiple keystrokes and mouse-clicks to get there. However, since DSC program is turned off at step 307, the process of getting to the desired screen is not captured (there may be multiple images shown on the screen before he gets to the desired one). Once he arrives at the desired screen, he activates the screen-capturing module as depicted at step 302.

And then the same process of capturing and exporting the images to the same destination file continues, so that non-sequential images are captured and stored in the same destination file, which may comprise images from different targeted computer programs or systems. At the end, when the user determines that no more screens are to be captured, the process ends at step 310. Those skilled in the art will appreciate that these multiple screens can be exported to multiple destination files based on the user's initial choices.

The screen capturing procedure described in FIG. 3 could be implemented in a stand-alone application. However, the screen capturing technology may be directly incorporated into other applications. By use of application programming interfaces (API) and other methodologies, programmers can easily integrate DSC capabilities into their software applications.

An API is an interface that a computer system, library or application provides in order to allow requests for services to be made of it by other computer programs, and/or to allow data to be exchanged between them. One of the purposes of an API is to describe how computer applications and software developers may access a set of functions (for example, within a library) without requiring access to the source code of the functions or library or requiring a detailed understanding of the functions' internal workings. APIs may be accessed through static libraries, dynamic link libraries (DLL), and other means.

In another embodiment of a DSC API, functions and methods to access FIG. 3, step 300 through 310, as well as additional DSC functionalities may be made available through an API. Also, DSC can be built to capture each desired screen only upon user specific keystroke(s)/mouse-click(s), therefore, eliminating the step of temporarily turning off screen capturing module in order to navigate to the next desire screen(s).

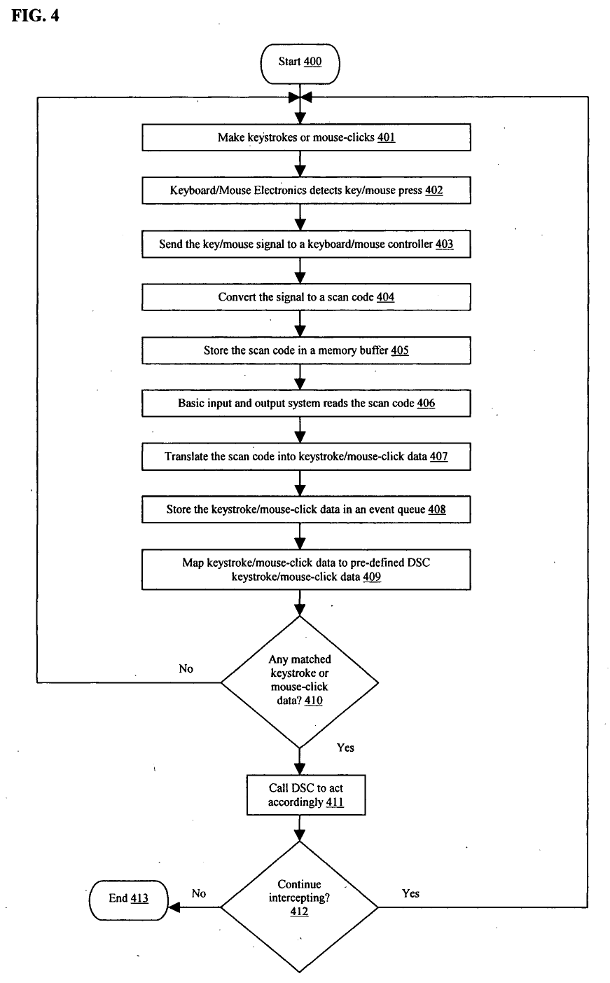

Referring to FIG. 4, therein is presented a high-level logic flow diagram illustrating how keystroke/mouse-click intercepting works. As represented in FIG. 4, the process starts at step 400 and then proceeds to step 401 whereby a user makes keystroke(s) or mouse-click(s). The keystroke/mouse-click electronics immediately detects the key or mouse press as shown at step 402, and sends the keystroke/mouse-click signal to a keyboard/mouse controller at step 403.

Next, the controller converts the signal into a scan code as indicated at step 404 and stores the scan code in a memory buffer at step 405. At this point, the Basic Input and Output System (BIOS) reads the scan code at step 406 and translates the scan code into keystroke/mouse-click data at step 407. And then, the keystroke/mouse-click data is stored in an event queue at step 408. DSC program then intercepts the keystroke/mouse-click data and maps the data to its pre-defined keystroke/mouse-click data as shown at step 409.

A determination is then made at step 410 as to whether any matching keystroke/mouse-click data is identified. If no matched keystroke/mouse-click data is found, the process goes back to step 401.

If yes, the respective DSC function is called to act accordingly as presented at step 411. For example, if the matched keystroke/mouse-click data is for Designated Screen. Capture (such as “Shift+PrtSc”), DSC calls its Screen Capturing Module to capture the current screen, and in response to the further keystroke(s)/mouse-click(s) from the user, to capture the subsequent desired screens. There is an option for DSC to produce screen capturing sounds each time a screen is captured (not shown on the flowchart). The generation of screen capturing sounds is enabled by a sound module that interfaces with a sound card and speakers. A typical sound could be similar to that made by a shutter of a mechanical camera.

At step 411, DSC does whatever it needs to do, such as calling its exporting function to export the captured images to a destination file, or calling its logging module, replaying module, and the like upon user instruction. Another determination is made at step 412 as to whether more keystrokes or mouse-clicks are to be intercepted. If yes, the process goes back to step 401 to capture a plurality of targeted screens. If no more keystrokes or mouse-clicks are to be intercepted, then the process ends at 413.

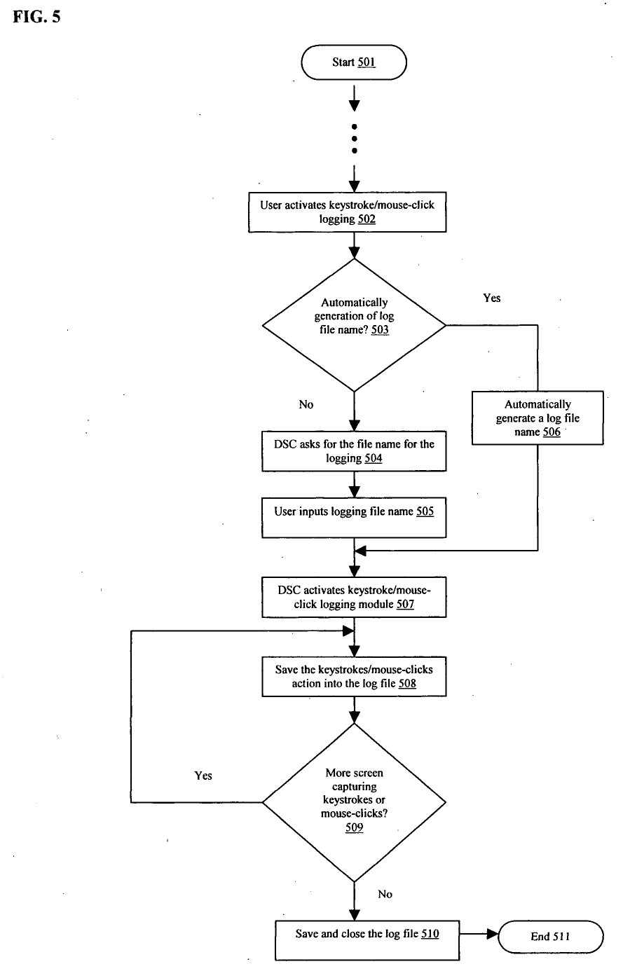

With reference now to FIG. 5, therein is depicted a high-level logic flowchart illustrating how keystroke/mouse-click logging works. As indicated, the process starts at step 501, the user performs whatever he needs to do and then reaches step 502 whereby he chooses to activate DSC program's keystroke/mouse-click logging module for screen capturing by invoking DSC keystroke/mouse-click logging function or by pressing at least one logging hotkey or logging mouse-click. DSC program can be set up to allow manual or automatic generation of a log file name at step 503. If manual, the program prompts the user to enter a logging file name at step 504, the user then inputs logging file name at step 505.

Alternatively, DSC program may automatically generate a generic file name (e.g., Log File 1) at step 506, which can be changed later when the user chooses to save the logging file.

Next, DSC program activates its keystroke/mouse-click logging module at step 507 and starts to save the keystrokes and/or mouse-clicks actions into the log file as depicted at step 508. The logging module saves the keystroke action information into the log file. If the action is a mouse-click, it also saves the location information or object information where the mouse is clicked on into the log file.

A determination is then made by the user as to whether he needs to continuously log more keystrokes and/or mouse-clicks for designated screen capturing at step 509. If yes, the process goes back to step 508 to continuously record all the keystrokes and/or mouse-clicks. If no, the user saves and closes the log file at step 510 and the process ends at step 511. It should be noted to those skilled in the art that the keystroke/mouse-click logging module can be temporally deactivated and reactivated to record only desired keystrokes or mouse-clicks.

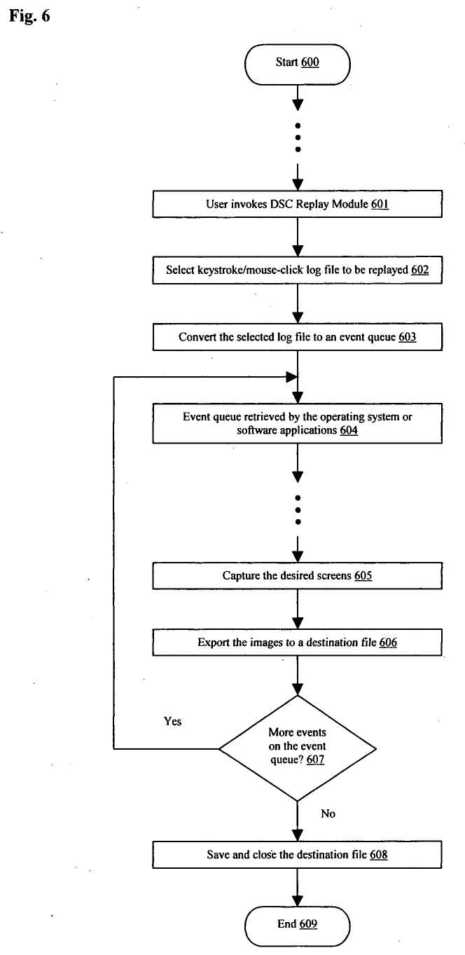

Now referring to FIG. 6, therein is presented a high-level flowchart depicting an exemplary process of how keystroke/mouse-click replaying works. The replaying module comprises an initializing means to initialize the replay of keystroke/mouse-click actions, a selection means for selecting which recorded keystroke/mouse-click log file is to be replayed, and a replaying means for replaying the recorded actions. Optionally, the replaying module further comprises a sorting means for sorting the recorded action list and/or a redundancy removal means for preventing the replay of redundant actions that lead to duplicate screen shots.

As represented in FIG. 6, the process starts at step 600, and then a user does whatever he needs to do (such as navigate to the screen whereby the keystroke/mouse-click recorded sequence starts) to reach step 601 wherein he invokes DSC Replay function. Upon invoking DSC reply, the user may be presented with a window to select the keystroke/mouse-click log file that needs to be replayed as indicated at step 602. Such log file was saved previously, indicating all the actions taken when a user used DSC to capture a plurality of screens.

Once the log file is selected, it is converted into an event queue at step 603. Such event queue is then retrieved by the operating system or software applications of which screens are to be captured. The operating system or software applications then follows the instruction of the event queue, such as navigating to the desired page or performing whatever actions it needs to do to reach step 605 whereby DSC program captures the desired screen(s) of the operating system or software applications. DSC program then automatically exports the captured image(s) to a destination file at step 606.

A determination is then made at step 607 as to whether there are more events on the event queue. If yes, the process goes back to step 604 whereby event queue is retrieved by the operating system or software application(s). And the loop continues until all events on the event queue are carried out. At this point, the process proceeds to step 608 to save and close the destination file wherein a plurality of screens are residing. The process then ends at step 609.

It should be noted to those skilled in the art that these multiple screens can be exported to multiple destination files based on user choices. Also, when the keystroke/mouse-click logging module is enabled at the start of the targeted computer program(s), the user can instruct DSC where the targeted computer program(s) are located in the computer. Then, DSC application can automate the entire process, starting from launching the targeted program(s), simulating the keystroke/mouse-click events to navigate to the desired screens within the targeted computer program(s), capturing the screen images, and exporting them into destination file(s).

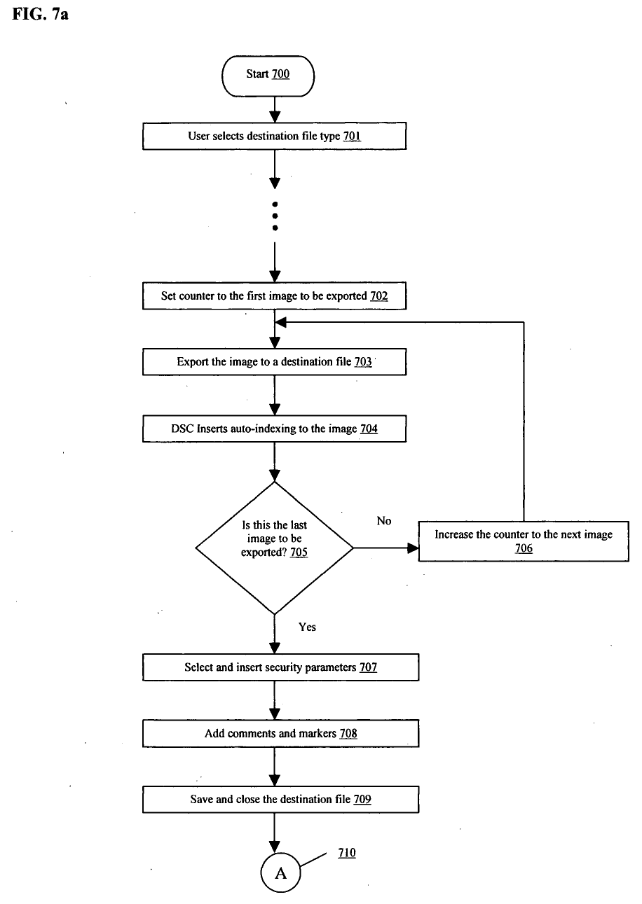

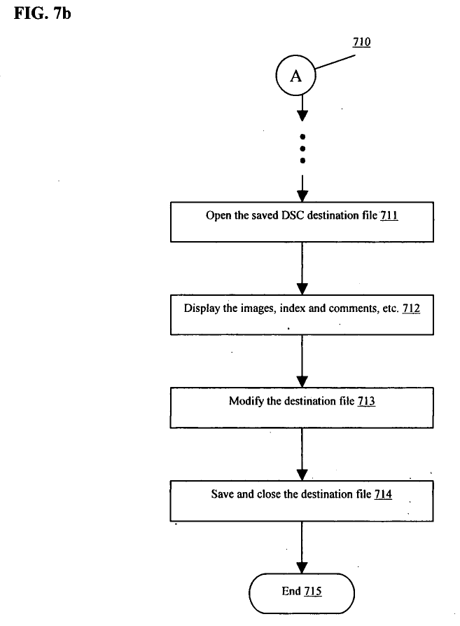

With reference to FIG. 7a, therein is presented a high-level logic flowchart illustrating the exemplary process of automatically indexing captured screens, assigning security attributes, displaying captured images within DSC, and modifying a DSC file. In addition to exporting screen shots to the destination file, other information may be added to the destination file, such as time/date stamps, digital signatures, metadata, user-entered comments, encrypted data, processed screen captures and the like.

As represented on FIG. 7a, the process starts at step 700 and thereafter proceeds to step 701 whereby a user is prompted to select the destination file type, such as Microsoft Word or Adobe PDF. The user then does whatever he needs to do, such as capturing a plurality of non-sequential screens using DSC. At this point, DSC sets a counter to the first image that is to be exported to a destination file with the chosen destination file type at step 702. For this particular example, the user chooses to export the image to a display area of DSC.

Then, DSC exports the first image to a destination file as shown at step 703. As soon as the image is exported, DSC automatically inserts an index (e.g., page number) to the image page of the destination file. The image page of the destination file is where the image is displayed. A determination is then taken at step 705 as to whether the image is the last one to be exported. If no, DSC increases the counter to the next image at 706 and the process goes back to step 703 to export the next image to the destination file(s) and automatically inserts the next index to the next image page. The loop goes on until no more images need to be exported, at which point, DSC inserts security parameters at step 707.

It should be noted to those skilled in the art that DSC can allow the user to select security parameters, such as making the destination file with Read-only, Alter, or Delete attributes, creating a digital ID or signature, putting in date/time stamps, allowing captured screen shots within the file to be reordered or to be copied to the clipboard, and whether the destination file may be printable or not.

Next, DSC allows the user to add comments and marks to the image file as shown at step 708. After which, the user saves and closes the destination file at step 709. The process then proceeds to step 710, which will be further elaborated in FIG. 7b.

In FIG. 7b, the process continues from step 710. The user performs whatever he needs to do, such as emailing the file to a recipient(s), using other applications on his computer, or logging on to his computer at a later time. Then, the user opens the previously saved destination file at step 711. DSC displays the captured images with indexes, comments, marks, and the like, that stored in the destination file on its display region at step 712. DSC allows the user to modify indexes, comments, marks, and the like, including the contents of the images based on the security settings previously configured at step 713. If the user gives the recipient write access to the file, the recipient will be able to make changes to the indexes and comments. The user can also allow a recipient to make changes to the images themselves based on selected security settings. Special index or notation may be shown, for example, inside the destination file or in the file property, to indicate whether the image contents are protected or not.

After the user modifies the destination file, the process then proceeds to step 714 whereby the user saves the changes and closes the file. The process then ends at step 715. It should be noted to those skilled in the art that the modification can take place during the initial screen-capturing phase. For example, the user can make modification prior to step 709.

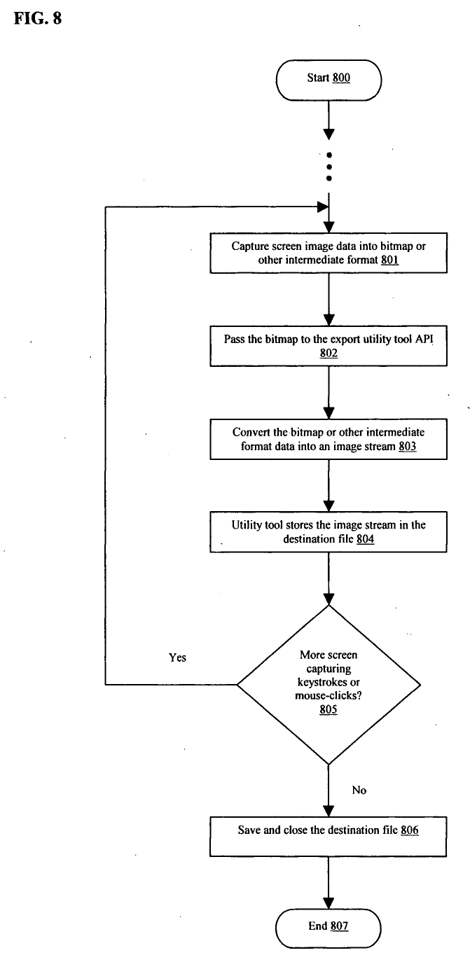

Now referring to FIG. 8, therein is presented a high-level diagram illustrating an exemplary process of how a plurality of screens are exported to a destination file. As elaborated in FIG. 3, the entire screen, certain window(s), or certain area(s) of the screen have been selected for capture, and their contents are encoded into an intermediate format. In one exemplary embodiment, screens may be encoded on a Windows platform using GDI. GDI (Graphical Device Interface) is a standard for representing graphical objects and transmitting them to various output devices. In this example, the device context (DC) of the desktop or window to be captured is obtained. A DC is a structure that defines a set of graphic objects and their associated attributes. One available graphic object is a bitmap that may be used for copying parts of the screen, and this bitmap can serve as an intermediate format for a captured screen. Once the DC for the window has been established, a bitmap can be created which will hold the contents of the captured screen.

The intermediate format of the captured screen image may be converted into a final format required for the destination file (see FIG. 3 for the description of the destination file). For example, a bitmap may be converted to another format such as Graphics Interchange Format (GIF), Joint Photographic Experts Group (JPEG), Portable Network Graphics (PNG), Tagged Image File Format (TIFF), or propriety formats. This step may be optional as the intermediate format may be suitable for the destination file. Format conversions may be required for several reasons such as: compatibility with the destination file requirements; converting to a compressed format for reduced file size; and other requirements. In addition to simple format conversions, a captured image may be processed by DSC or other software(s) to render an image(s) or other information required for the destination file. For example, a user can convert captured color images into grayscale images by selecting a grayscale conversion option in DSC. Other information that may be made available to the destination file is image size, file format, compression algorithm used, etc.

As shown on FIG. 8, the process starts at step 800 whereby a user does whatever he needs to do, such as activate the screen-capturing module to capture the current screen. Once the user activates the screen-capturing feature, DSC program automatically transforms the image into a bitmap or other intermediate format as depicted at step 801. Next, DSC program passes the bitmap to the export utility tool API at step 802. The program further converts the bitmap or other intermediate format data into an image stream at step 803. The utility tool then stores the image stream into the destination file at step 804.

At this point, a determination is made as to whether more screens are to be captured. If so, the process goes back to step 801 and repeats the same steps of exporting images to the same destination file, so that the file contains a plurality of screens of at least one targeted computer program or system. If no more screens are to be captured, then the destination file is saved and closed at step 806, and the process ends at step 807. It should be noted that these images could be exported to multiple destination files depending on the user's initial choices.

A destination file may be any computer-generated document capable of storing screen shots. Common formats for storage include Adobe PDF, MS Word, etc. In one embodiment, the screen shot exporting process is implemented in C# where a MS Word document is opened, the captured screen is saved to the clipboard as a bitmap, and the bitmap is exported to the Word document. An example of how this may be carried out is shown below:

private void Capture( )

{

//...
//
// Create Word document.
Word.Application app = new Word.ApplicationClass( );
object file = @“c:\ScreenCapture.doc”;
object miss = System.Reflection.Missing.Value;
object otrue = true;
object ofalse = false;
Word.Document doc =

app.Documents.Open(ref file,ref miss,ref ofalse,ref miss,
ref miss,ref miss,ref miss,ref miss,ref miss,ref miss,
ref miss, ref miss,ref miss,ref miss,ref miss,ref miss);

//
// Other initializing code here...
//
// Screen capturing loop:

//...
// Save the captured screen to the clipboard.
//...
// Paste captured screen residing on the clipboard
// into the Word document.
//...
object start = rngStart;
object end = rngEnd;
Word.Range rng = doc.Range(ref start,ref end);
rng.Paste( );
//...
doc.Save( );
//...

//
// End screen capturing loop
app.Quit(ref otrue,ref miss,ref miss);

}

With Word and other Microsoft Office applications, virtually all of the actions that can be performed manually through a user interface can also be performed programmatically. Word exposes this programmatic functionality through an object model. The object model is a collection of classes and methods that serve as counterparts to the logical components of Word. For example, there is an Application object, a Document object, and a Paste object, each of which contain the functionality of those components in Word. By applying this automation technology as depicted in the example above, screen shots may be exported to a Word document.

The exemplary screen shot exporting algorithm given above is not intended to limit the present invention. Other alternative algorithms may be used without departing from the scope of the invention.

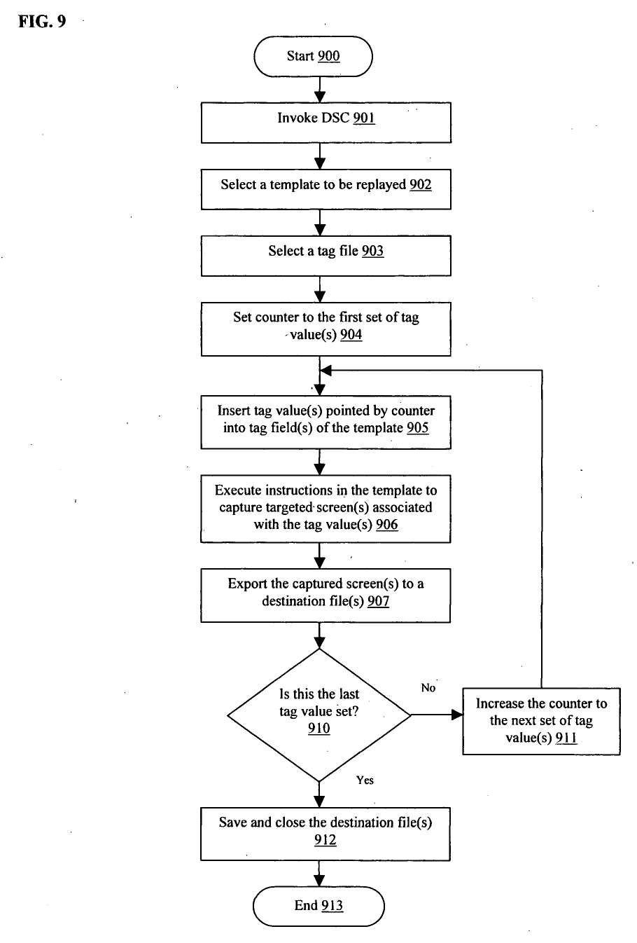

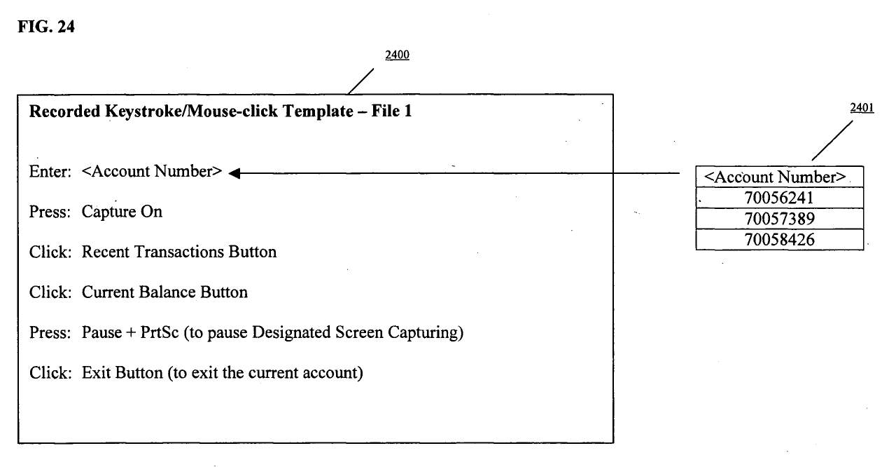

Now referring to FIG. 9, therein is presented a high-level diagram illustrating an exemplary process of how a template converted from a log file can be used to automatically generate a plurality of screen shots by replacing template tags with new values from a tag file. Examples of tags are customer account numbers, access request ticket numbers, or help desk ticket numbers, etc (see more details about replacing tag values in FIG. 24).

It should be noted to those skilled in the art that a recorded keystroke/mouse-click log file could be converted into a template by identifying certain field values and replacing them with tags. Users can create tag files that contain tag values that will be automatically inserted into tag fields of a template.

As indicated on FIG. 9, the process starts at step 900, and thereafter proceeds to step 901 whereby a user invokes DSC program. Next, the user selects a template that he wants to be replayed as shown at step 902. This is followed by the user selecting a tag file that contains tag values at step 903. DSC program sets a counter to the first set of tag value(s) upon the user activating replay as indicated at step 904. The program then inserts tag value(s) in the tag file pointed by counter into tag field(s) of the template at step 905. Next, the program executes instructions in the template to capture targeted screen(s) associated with the tag values of the selected tag file as shown at step 906. The captured screen(s) are exported to a destination file(s) at step 907. A determination is then made as to whether the tag value set selected is the last tag value set at step 910. If no, the process continues to step 911 whereby DSC program increases the counter to the next set of tag value(s). And the process goes back to step 905 to capture targeted screen(s) for the next set of tag values. The looping continues until the screen(s) of last set of tag values are captured, thereafter, the process proceeds to step 912 whereby the destination file(s) is saved and closed. The entire process ends at step 913.

Those skilled in the art should appreciate that the log file can include keystroke/mouse-click commands, commands derived from voice instructions, and the combination of keystrokes/mouse-clicks and voice commands.

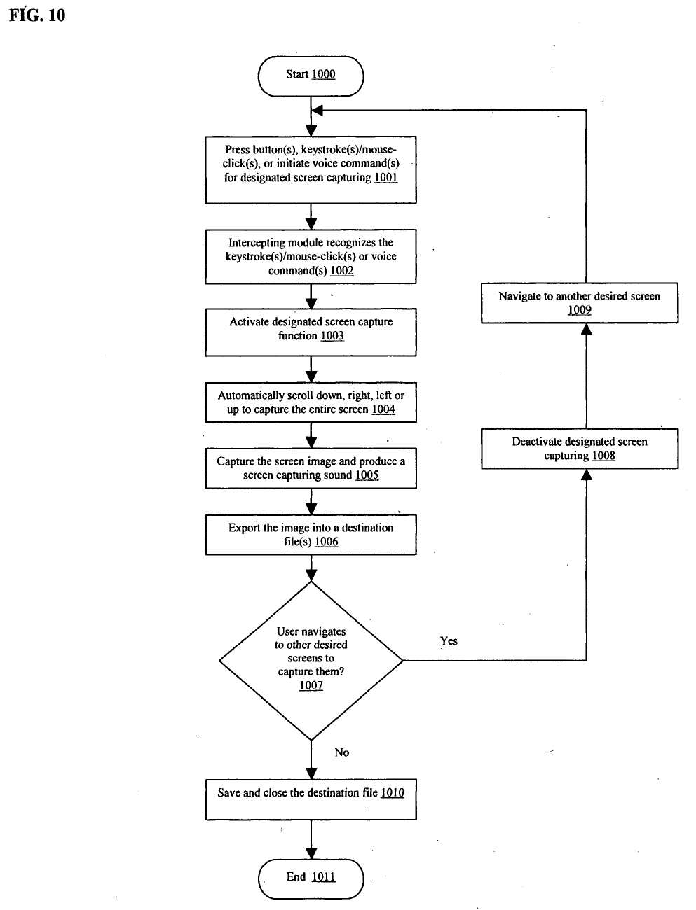

With reference to FIG. 10, therein is presented a high-level logic flow diagram depicting an exemplary process and program showing how a targeted computer program or system incorporates DSC to allow selection of non-sequential screens and producing a plurality of screen shots. As indicated, the process starts at step 1000, and then proceeds to step 1001 whereby a user performs several alternative actions, such as presses built-in designated screen capturing button(s) in the targeted program or system wherein screens are to be captured; presses keystroke(s)/mouse-click(s) for designated screen capturing or initiates voice command(s) for designated screen capturing. The intercepting module recognizes such keystroke(s)/mouse-click(s) or voice command(s) as shown at step 1002. DSC program then activates its designated screen capturing function at step 1003.

Next, DSC may automatically scroll down, right, left or up to capture the entire screen that may be out of the display region on a computer monitor as depicted at step 1004. During the automatic scrolling, DSC program captures the screen image(s) and produces screen capturing sounds each time a screen is captured as shown at step 1005. It should be noted to those skilled in the art that the generation of screen capturing sounds is an optional feature. Next, DSC program exports the image(s) into a destination file(s) at step 1006.

A decision is made at step 1007 by the user as to whether he wants to navigate to other desired screens in the same targeted software or different ones to capture them. If yes, the user temporarily deactivates the designated screen capturing by pressing a built-in button in the targeted computer program or system, by pressing hotkey(s)/mouse-click(s) or by giving voice command(s) as depicted at step 1008. Normally in this scenario, the next desired screen to be captured requires several keystrokes or mouse-clicks to reach. DSC is preferably built in a way that it would automatically capture the resulting screens in response to keystroke(s)/mouse-click(s) or voice command(s) after its designated screen capturing function is activated. That is why temporary disabling of the designated screen capturing function may be needed when capturing non-sequential screens.

The user then navigates to next desired screen as shown at step 1009, and the process goes back to step 1001 to repeat the process of capturing the desired image(s), and exporting it to the destination file(s). The loop continues until no more screens are to be captured, and at that point of time the process proceeds to step 1010 to save the images and close the destination file. Finally, the process ends at step 1011.

Those skilled in the art will appreciate that the temporary deactivation of DSC is an optional step. For example, if the next page of the targeted computer program is the next desired screen, the user only needs to press “Next Page”, and the process goes back to step 1001 to automatically capture the next page screen and export it to the destination file(s). DSC program also allows a user to undo a prior action if the user realizes that it is a mistake. For example, the user presses “Next Page”, DSC automatically captures the next page screen and exports it to the destination file. He then realizes the screen is not what he wants. At this point, he can select a function in DSC (e.g., click Undo button) to automatically remove the next page screen shot from the destination file, and then proceed with what he needs to do.

DSC can also be programmed to capture each desired screen only upon a user activating designated screen capturing via a keystroke(s), mouse-click(s) or voice command(s). In other words, the user does not need to temporally deactivate designated screen capturing function when capturing non-sequential screens because each desired screen is captured only upon user specific keystroke(s), mouse-click(s) or voice command(s) input.

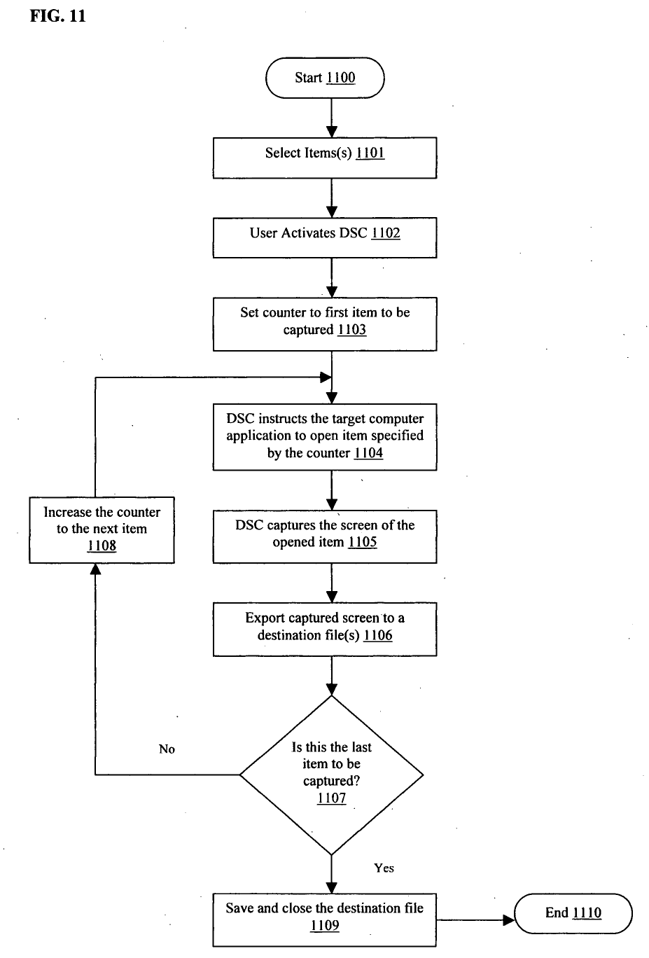

Now referring to FIG. 11, therein is presented a high-level logic flowchart illustrating an exemplary process of how DSC allows selection of items to produce a plurality of screen shots without the need for a user to open up each item. As depicted, the process starts at step 1100 and thereafter proceeds to step 1101 whereby a user picks items in a targeted program or system. For example, the user picks several email items from his inbox. Next, the user activates DSC program as shown at step 1102.

DSC program then sets a counter to the first item to be captured at step 1103. It instructs the targeted computer application or system to open the item specified by the counter at step 1104. Upon the opening up of the item, DSC program captures the screen of the opened item at step 1105. Next, DSC exports the captured screen to a destination file as shown at step 1106. A determination is then made by DSC program as to whether this is the last item selected by the user as shown at step 1107. If No, DSC increases the counter to the next item at step 1108, and the process goes back to step 1104 to open up and capture the remaining items and export them to the destination file(s). If Yes, DSC saves the images and closes the destination file at step 1109, and the process ends at step 1110.

With reference to FIG. 12, therein is presented a high-level logic flowchart illustrating an exemplary process of how a plurality of screens of at least one targeted computer program or system can be captured upon user voice commands. As indicated, the process starts at step 1200, thereafter the user navigates to a desired screen, and says, for example “Capture On.” at step 1201. A microphone that is connected to a sound card or other audio processing hardware digitizes the audio signal at step 1202. This digitized representation of the user's speech is fed into a speech recognition module at step 1203 that takes a determination at step 1204 as to whether the verbal commands issued by the user match a predefined list of DSC verbal commands. If a match is found, the screen is captured at step 1205, then the image(s) is automatically exported to a destination file(s) at step 1206. The program enables automatic scrolling to capture the entire screen that could be out of the display region as depicted in FIG. 10. If no match is found, the current screen is not captured and the process goes back to step 1201.

Next, the user determines whether more voice commands are to be given as shown at step 1207. If yes, the process goes back to step 1201 for the user to give a new voice command, and then for the audio digitizer to receive and process the voice signals, capture the next desired screen(s) and export the image(s) to the destination file(s). In one exemplary embodiment of the invention, the user says “Next Page.”, the speech recognition module receives the digitized voice signal, searches for a matching voice command, executes the command by navigating to the next page of the targeted computer programs or computer systems, activates DSC to capture the screen, and exports the image to the same destination file by appending the second image at the end of the first one. It should be noted to those skilled in the art that exporting the image to the same destination file is one embodiment of this invention; however, the invention includes the option of automatically exporting the image to a separate destination file.

In another exemplary embodiment of the invention, the user says “Capture Off” after step 1207, DSC processes the command and turns off the screen capturing module. Then the user does whatever he needs to do, such as taking several steps to navigate to another desired screen of the same or different targeted computer programs or computer systems either by voice commands or by keystrokes or mouse-clicks. When the desired screen is found, the user then says “Capture On”, and the same process follows from step 1201 to 1206, and the proceeds to the loop if more voice commands are given after step 1207.

In yet another exemplary embodiment of the invention, DSC may be programmed to only perform capturing when certain voice command(s) are given, therefore, the user may not need to temporarily deactivate designated screen capturing to capture non-sequential screens. The captured images are automatically exported to the destination file(s).

It should be noted to those skilled in the art that keystroke or mouse-clicks instructions can be combined with voice commands at different points in the process.

The loop continues until no more voice commands are to be issued. At this point, the process continues to step 1208 whereby the user saves and closes the destination file. The entire process then ends at step 1209.

Also, It should be noted to those skilled in the art that other methods described above pertaining to keystrokes and mouse-clicks also apply to voice commands, such as logging voice commands or the combination of voice commands, keystrokes or mouse-clicks; replaying a voice command log or a combination log to simulate the designated screen capturing process; batch processing of voice commands or the combination to simulate the designated screen capturing process; automatic indexing, adding security attributes, inserting comments and marks, etc., into the destination file(s).

In addition, the speech recognition module can incorporate a learning unit to enable it to better recognize voice instructions from different people. Various speech recognition technologies to process and store voice commands can be used, such as Frequency Estimation, Hidden Markov Models, Pattern Matching Algorithms, Neural Networks, Matrix Representation, Decision Trees, and Anti-Speaker, etc.

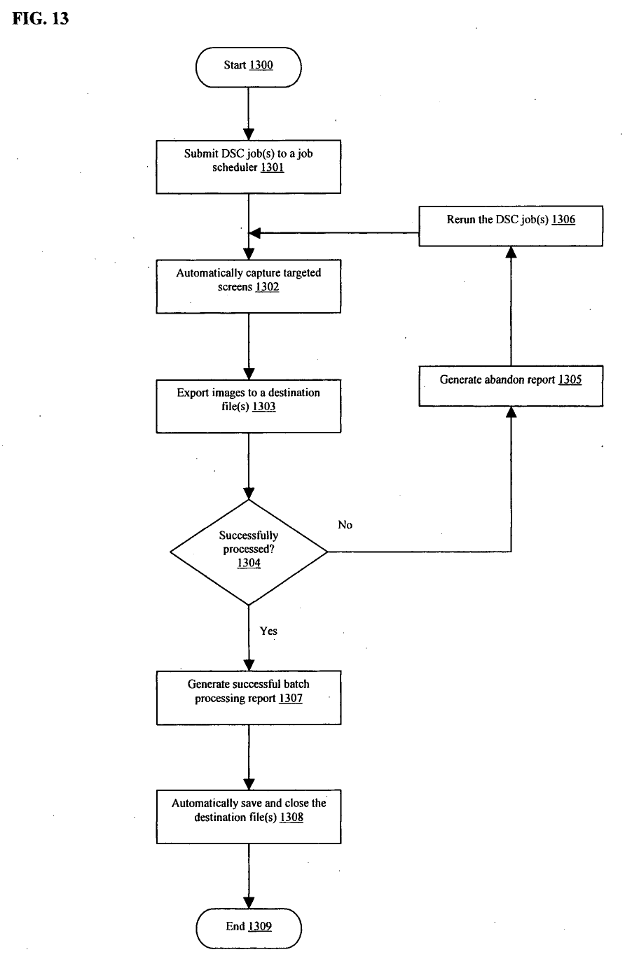

Now referring to FIG. 13, therein is presented an exemplary process of how DSC batch processing works. Batch processing is the execution of a series of programs or jobs, in the context of this invention, a series of DSC screen capturing activities, on a computer system without human interaction. By submitting such jobs to a job scheduler, a plurality of interval screen capturing operations can be automatically executed at a scheduled time, thus eliminating mundane manual operations. Batch job processing reports enable users to monitor any failed DSC jobs.

As depicted on FIG. 13, the process starts at step 1300 and thereafter proceeds to step 1301 whereby DSC job(s) are submitted to a job scheduler to be processed at a scheduled time. When the scheduled time arrives, the DSC job(s) are processed to automatically capture targeted screens as shown at step 1302. It will be appreciated by those skilled in the art that DSC job(s) normally contain pre-recorded designated screen capturing activities triggered by keystrokes, mouse-clicks, and/or voice commands. The execution of DSC job(s) re-performs the entire capturing process automatically without human intervention. The captured images are then automatically exported to a destination file(s) at step 1303.

A determination is made by the batch scheduling system as to whether the batch job(s) are processed successfully at step 1304. If no, the system generates batch job abandon report(s) at step 1305, and may rerun the job(s) at step 1306 to automatically capture targeted screens at step 1302.

If the DSC jobs are processed successfully, the batch scheduler then generates successful batch processing reports at step 1307. And DSC program automatically saves and closes the destination file(s) that contain captured images of at least one targeted computer programs or computer systems at step 1308. The process ends at step 1309.

FIG. 14 is an illustration of an exemplary display 1400 of a DSC GUI Interface that may be presented to a user according to one embodiment of the present invention. For simplicity sake, only two capturing profiles 1401 and 1402 are shown on display 1400. Capturing profile “Displayed Screens” 1401 allows a user to capture a plurality of displayed screens that could be non-sequential of a least one computer program or system. Capturing profile “Scrolling Windows” 1402 enables automatic scrolling of entire windows of the targeted computer program or systems that is outside of the display region to capture these entire windows.

After a capturing profile is chosen, a user presses the “Capture On” button 1403 or keystroke(s)/mouse-click(s) (for example, “Shift+PrtSc”) to instruct DSC to capture the current targeted software screen and any subsequent screens resulting from keystroke(s) or mouse-click(s) (for example, PgUp, PgDn, Next Page, Previous page). These captured screens are exported to a destination file(s). If the user wants to capture non-sequential screens of the same targeted software or different ones at one point, he presses “Capture Off” 1404 or keystroke(s)/mouse-click(s) (for example, “Pause+PrtSc”), and then navigates to the desired screens and reactivate “Capture On” to capture them and export them to the destination file(s).

In another embodiment of the invention, desired screens are captured and automatically exported to the destination file(s) only upon certain keystroke or mouse-click instructions. There is no need for the user to temporally turn off designated screen capturing. For example, the user presses a “Capture” button (not shown) or keystroke(s)/mouse-click(s) (for example, “Shift+PrtSc”) to instruct DSC to capture the current targeted software screen, which is automatically exported to a destination file. Then the user navigates to another desired screen and presses the “Capture” button or “Shift+PrtSc” to capture the next desired screen, which is automatically exported to the destination file(s). This process continues until all desired screens are captured and automatically exported to the destination file(s).

It will be noted that other functional buttons for automatic scrolling and capturing that are not shown on the display 1400 may be included according to the present invention. Also, the voice recognition and learning unit not shown on the display 1400 may be included to capture a plurality of screen images of at least one targeted computer application or computer system upon user-issued voice commands.

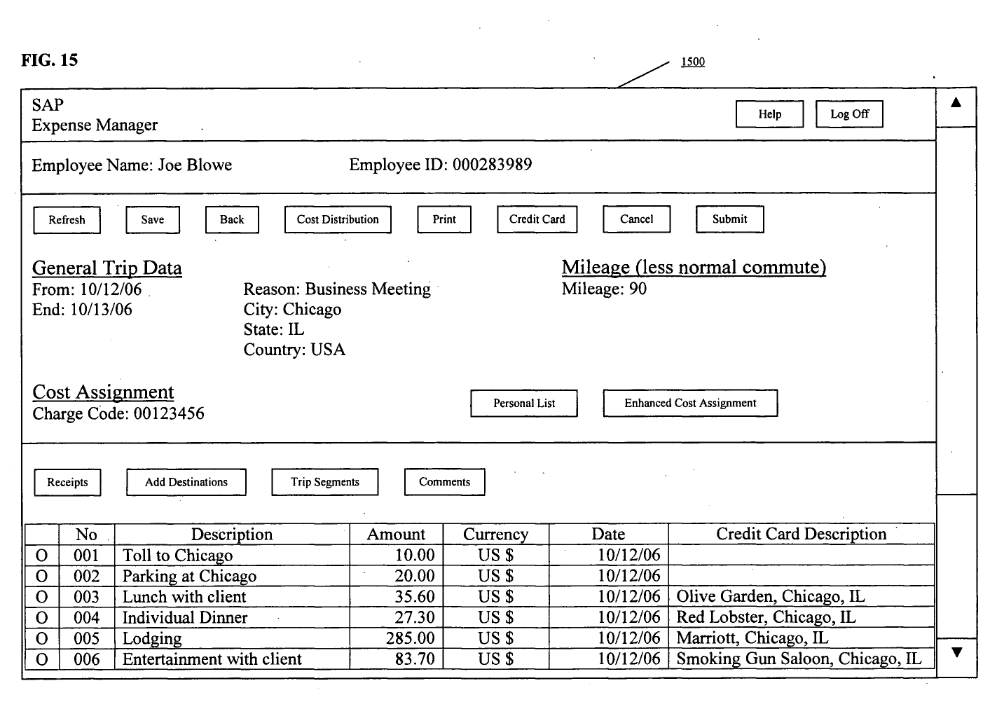

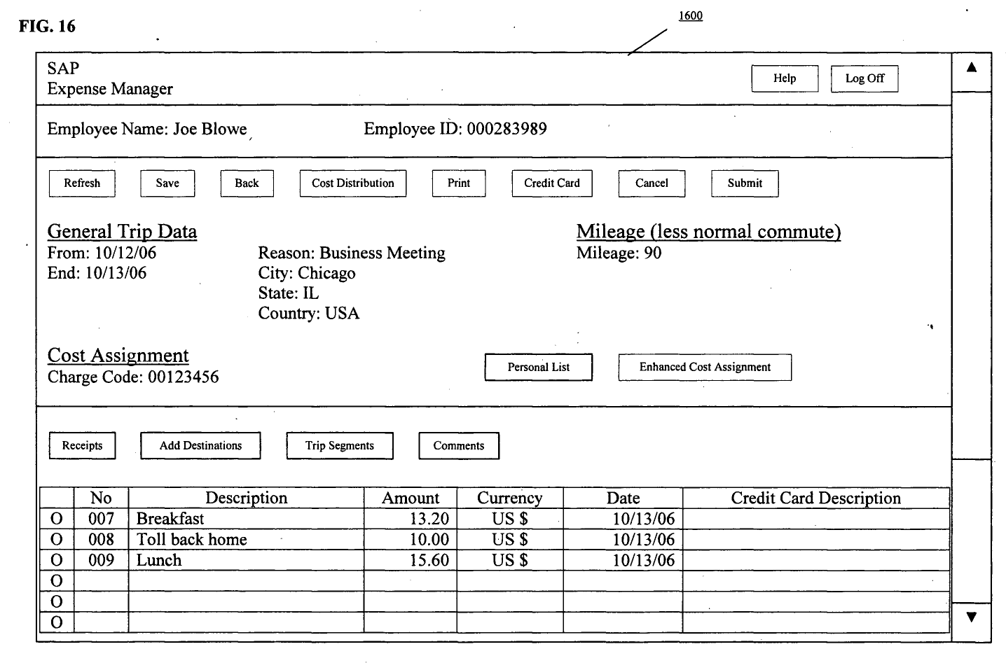

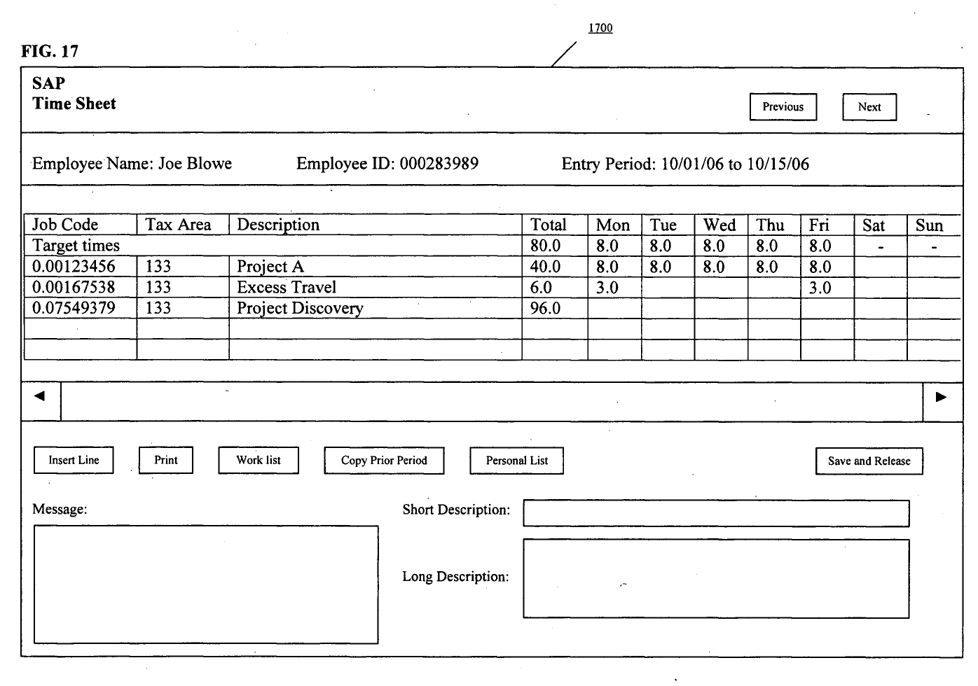

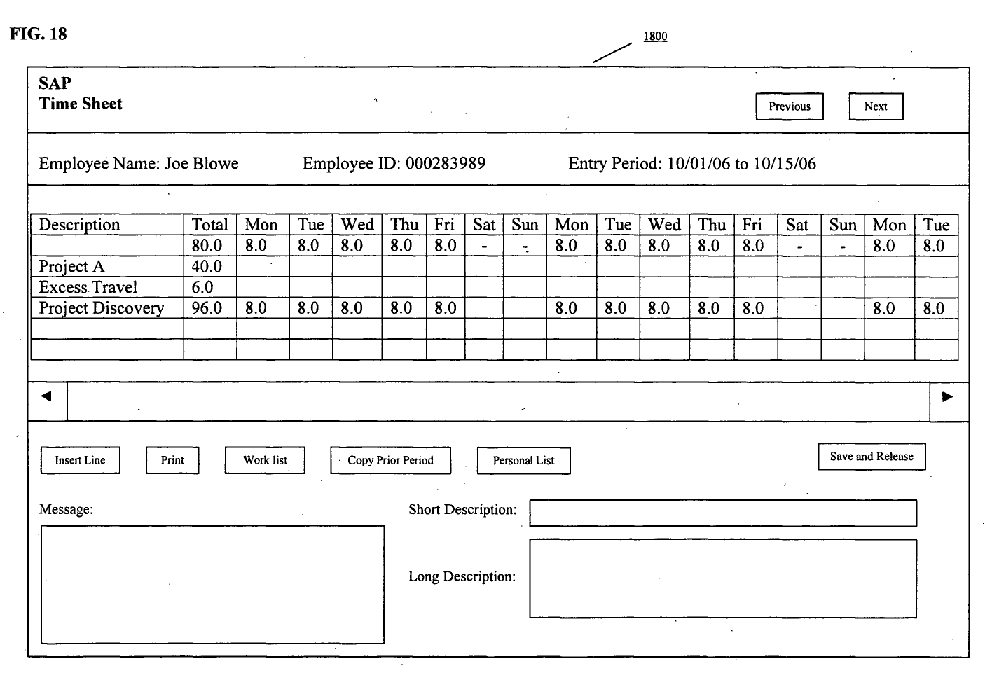

FIG. 15 to FIG. 19 are illustrations of exemplary displays of how DSC is used to capture a plurality of SAP screens. As indicated on FIG. 15, the display 1500 is a representation of a SAP Expense Manager screen that is to be captured by DSC. DSC program either causes the Expense Manager screen to automatically scroll down in order to capture the out of the range display 1600 of FIG. 16 or automatically captures the out of range display 1600 in response to a user's keystroke(s) or mouse-click(s) (e.g., press PgDn). The user then temporally deactivates DSC, and navigates to a SAP Time Sheet screen display 1700 as indicated on FIG. 17. Next, the user activates DSC to capture display 1700. Similarly, DSC program either causes the SAP Time Sheet screen to automatically scroll right in order to capture the out of range display 1800 shown in FIG. 18 or automatically captures the out of range display 1800 in response to the user's keystroke(s) or mouse-click(s) (e.g., drag the scrolling bar to right and release).

Alternatively, the capturing program can be configured such that it only captures desired screens when the user activates the designated screen capturing function each time. Therefore, there is no need for the user to temporarily deactivate DSC in order to navigate to the next desire page.

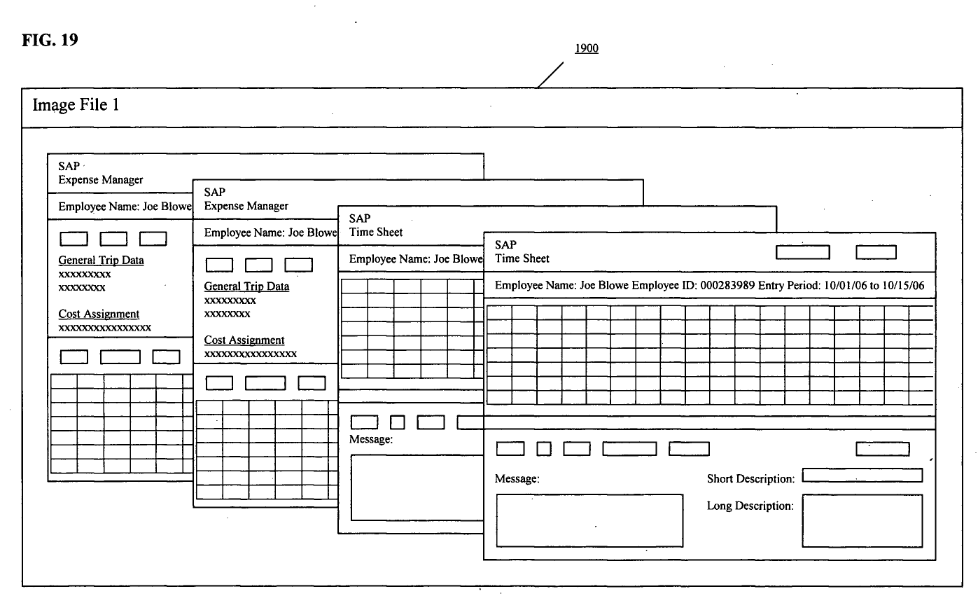

All these captured images are automatically exported to a destination file as shown in FIG. 19. It should be noted to those skilled in the art that the captured images of the Expense Manager Report and Time Sheet Report could be continuous, rather than in separate pages, and the display of these images can be sequential and be shown one at a time, rather than what is shown at display 1900 of FIG. 19 which is aimed at illustrating that all screens are captured and placed in the same destination file. Also, such images can be exported to separate destination files based on initial configurations.

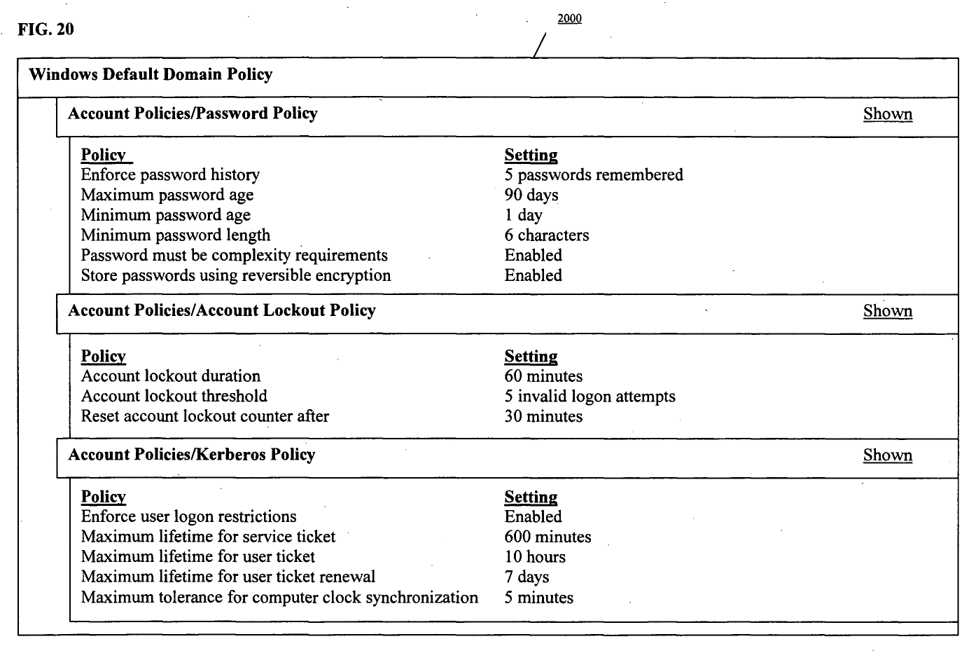

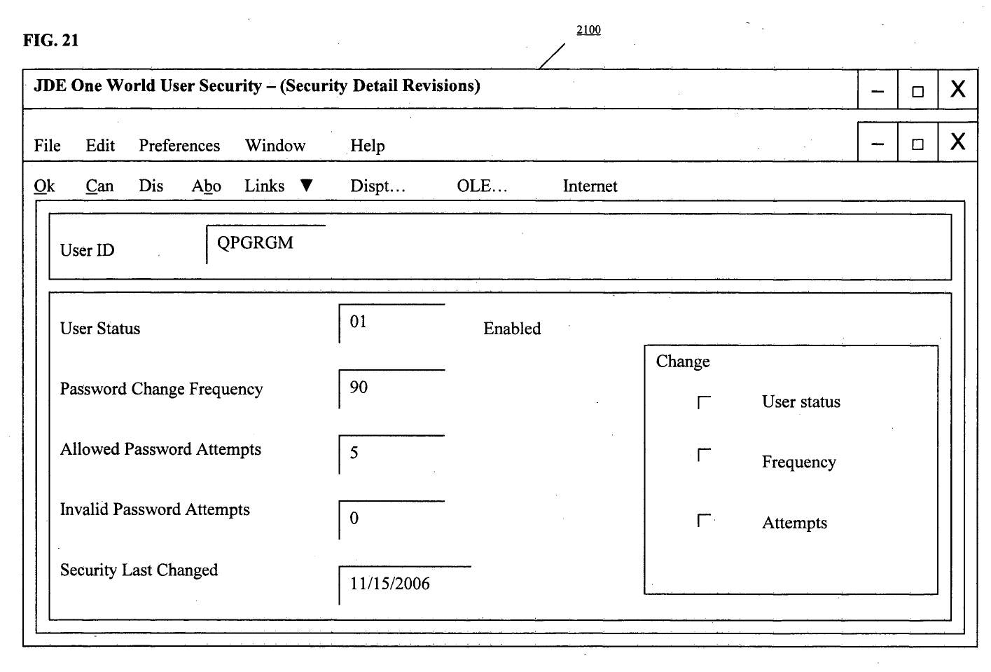

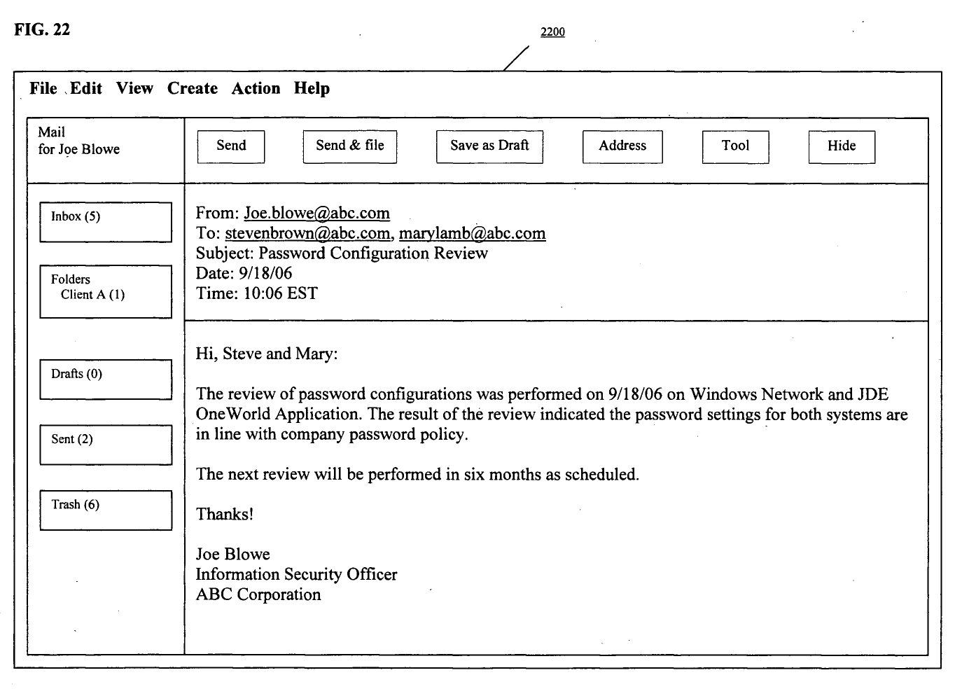

FIG. 20 to FIG. 23 are illustrations of exemplary displays of how DSC is used to capture a plurality of screens of multiple systems. As indicated on FIG. 20, a screen display 2000 of Windows Default Domain Policy is captured by DSC and exported to a destination file. Next, the user temporarily deactivates DSC, and navigates to a JDE password configuration screen display 2100 of FIG. 21. At this point, the user activates DSC to capture this screen, and DSC automatically exports the image to the same destination file. The user then temporarily deactivates DSC again, and navigates to his email that shows his review of password configuration as shown on display 2200 of FIG. 22. Subsequently, the user reactivates DSC to capture the email display 2200, and DSC automatically exports the image to the same destination file. The images can be displayed in DSC display region and the display can be minimized on the screen.

Alternatively, the capturing program can be configured such that it only captures desired screens when the user activates the designated screen capturing function each time. Therefore, there is no need for the user to temporarily deactivate DSC in order to navigate to the next desire page. All these captured images are automatically exported to a destination file(s).

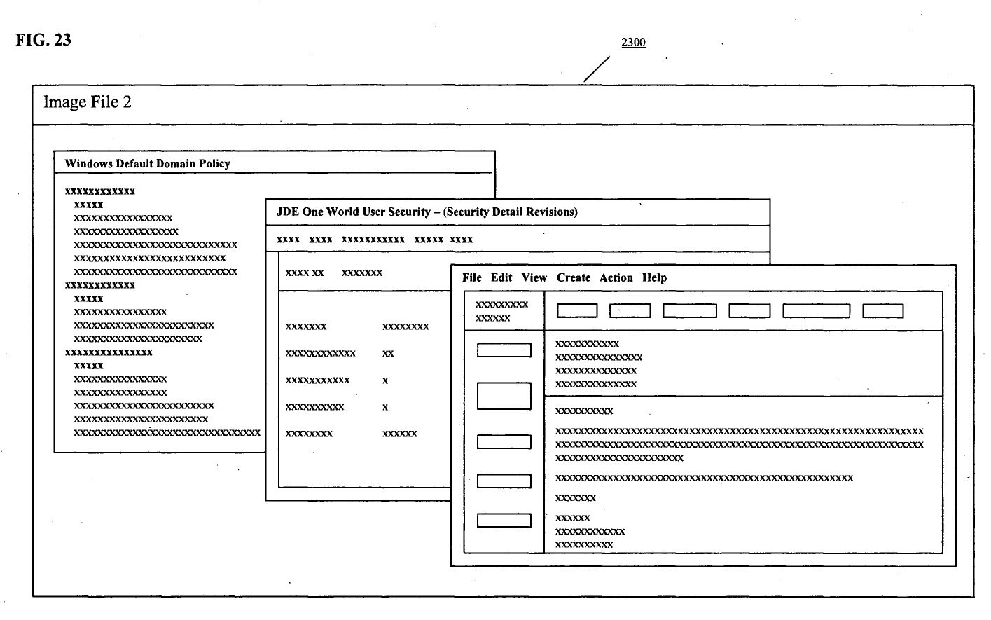

FIG. 23 illustrates an exemplary display 2300 of these three screen images captured from different computer systems. It should be noted to those skilled in the art that the display of these images can be sequential and one at a time, rather than what's shown on FIG. 23 which is aimed at illustrating that all screens are captured and placed in the same destination file. Also, such images can be exported to separate destination files based on initial configurations.

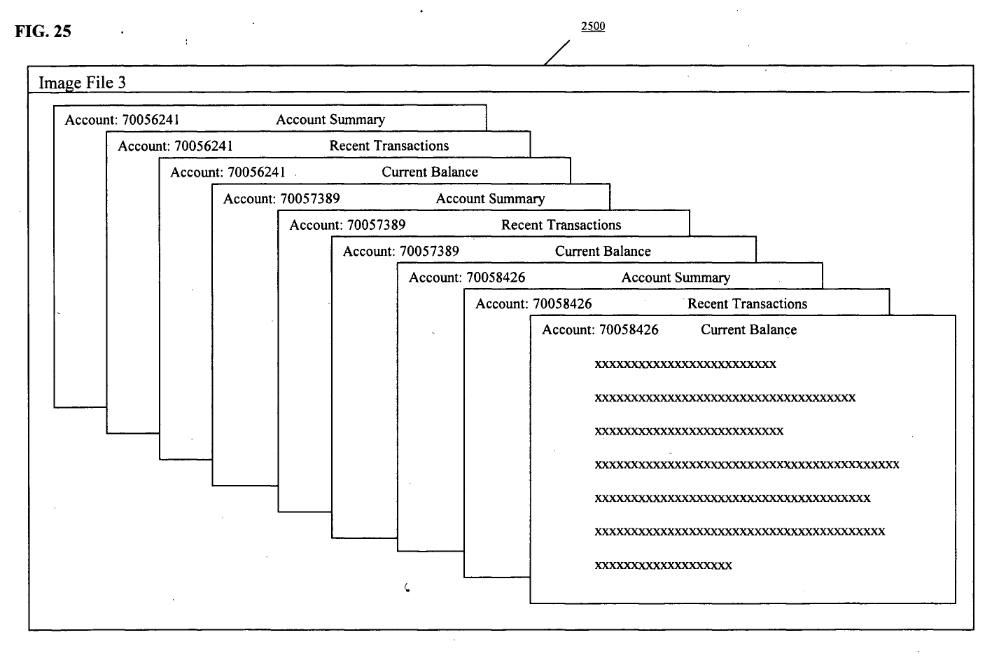

FIG. 24 and FIG. 25 are exemplary displays of a keystroke/mouse-click recorded log file that is converted by a user into a template to generate a plurality of screen shots of similar accounts in targeted software. As an example, a log file records a user entering account number 70024185, and then pressing DSC “Capture On” button to capture the account summary screen of account 70024185. DSC automatically exports the captured screen to a destination file. The user then clicks “Recent Transaction Button” on the targeted software account summary screen of account 70024185. In response to the click, DSC automatically captures the recent transaction screen of account 70024185 and exports it to the same destination file (e.g., append the image after the first image on the second page of the destination file). Next, the user clicks “Current Balance Button” on the targeted software recent transaction screen of account 70024185. In response to the click, DSC automatically captures the current transaction screen of account 70024185 and exports it to the same destination file. Subsequently, the user presses keystroke(s) or mouse-click(s) (e.g., Pause+PrtSc) to deactivate designated screen capturing, and then clicks exit button to exit account 70024185 and goes back to the initial account login screen.

The exemplary log file can be converted into a template by replacing certain key data with tags. For example, the previously discussed log file is converted into a template by replacing the text “70024185” with a tag denoted by <Account Number> in display 2400. A template can be repeatedly executed, with the tags being replaced with user-specified data residing in a tag value file. For example, three exemplary accounts 70056241, 70057389, 70058426 are entered by a user in a tag value file as shown at display 2401. When the template and the tag file are selected by the user for replay, DSC automatically inserts a tag value in the appropriate template tag, and executes the same process depicted above to capture the account summary, recent transactions and current balance screens of these three accounts in the order listed in the tag value file, and automatically exports them into a destination file as shown on display 2500 of FIG. 25.

It should be noted to those skilled in the art that the display of these images can be sequential and one at a time, rather than what is shown on FIG. 25 which is aimed at illustrating that all screens are captured and placed in the same destination file. Also, such images can be exported to separate destination files based on initial configurations.

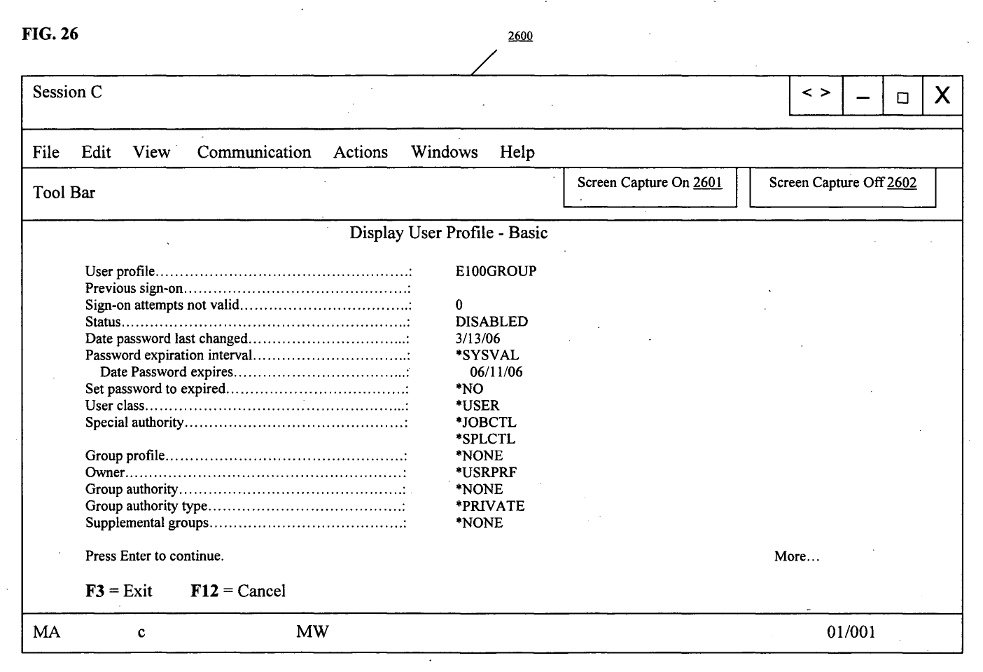

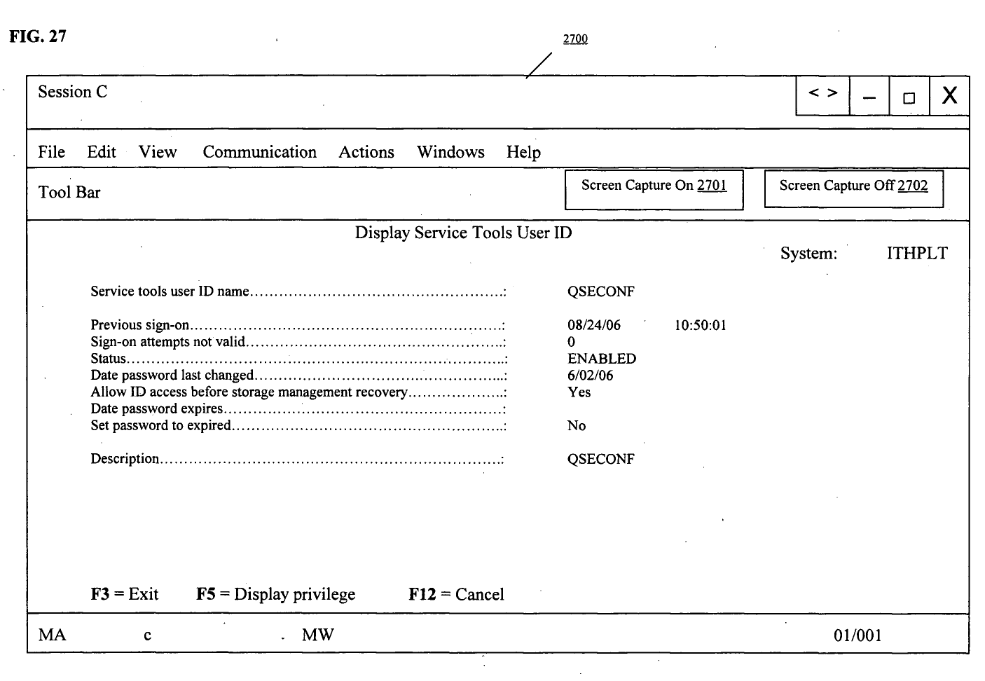

FIG. 26 to FIG. 28 are exemplary displays of how a targeted computer software incorporates DSC program to allow selection of non-sequential screens and produce a plurality of screen shots. As depicted on display 2600 of FIG. 26, DSC is built into this targeted software wherein screens are to be captured. When the user presses “Screen Capture On” button 2601, DSC is activated and captures the current displayed screen. In this exemplary display, the user subsequently presses “Screen Capture Off” button 2602 to pause the capturing. The user then navigates to another desired screen as shown on display 2700 of FIG. 27. At this point, the user reactivates DSC by pressing the built-in button “Screen Capture On” 2701 to automatically capture this desired screen. Then, the user presses “Screen Capture Off” button 2702 to pause the capturing. Similar actions can go on until the user captures all desired screens.

Alternatively, DSC can be configured such that it only captures desired screens when the user activates the designated screen capturing function each time. Therefore, there is no need for the user to temporarily deactivate DSC in order to navigate to the next desire page.

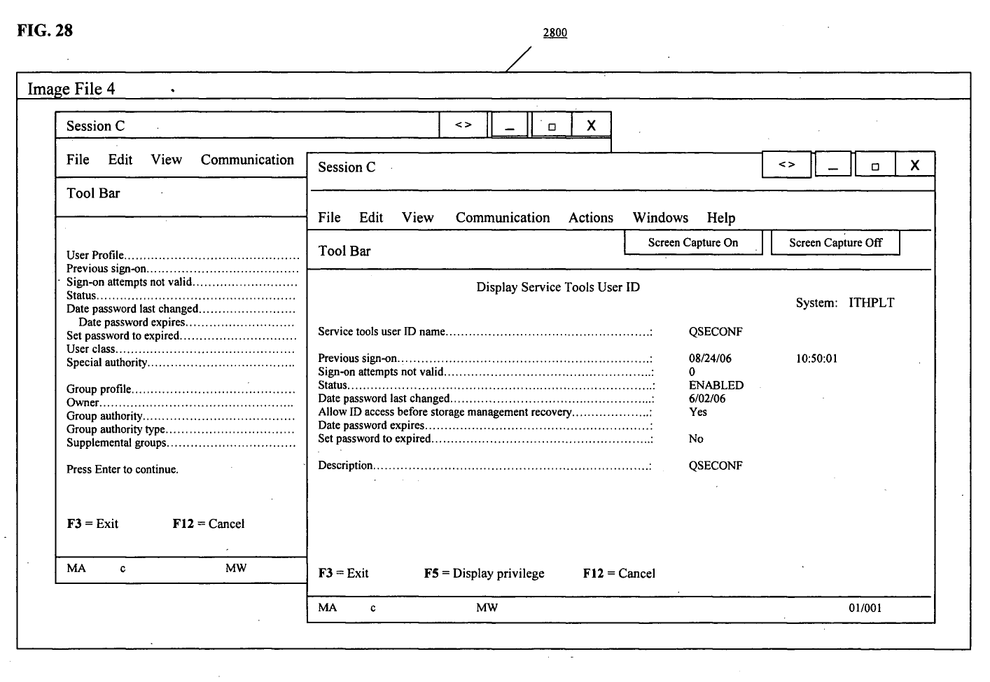

All captured images are automatically exported to a destination file(s). The user may then open destination file to view all captured screens. For simplicity sake, FIG. 28 only shows two screens captured as indicated on display 2800. It should be noted to those skilled in the art that the display of these images can be sequential and one at a time, rather than what is shown on FIG. 28 which is aimed at illustrating that all screens are captured and placed in the same destination file. Also, such images can be exported to separate destination files based on initial configurations.

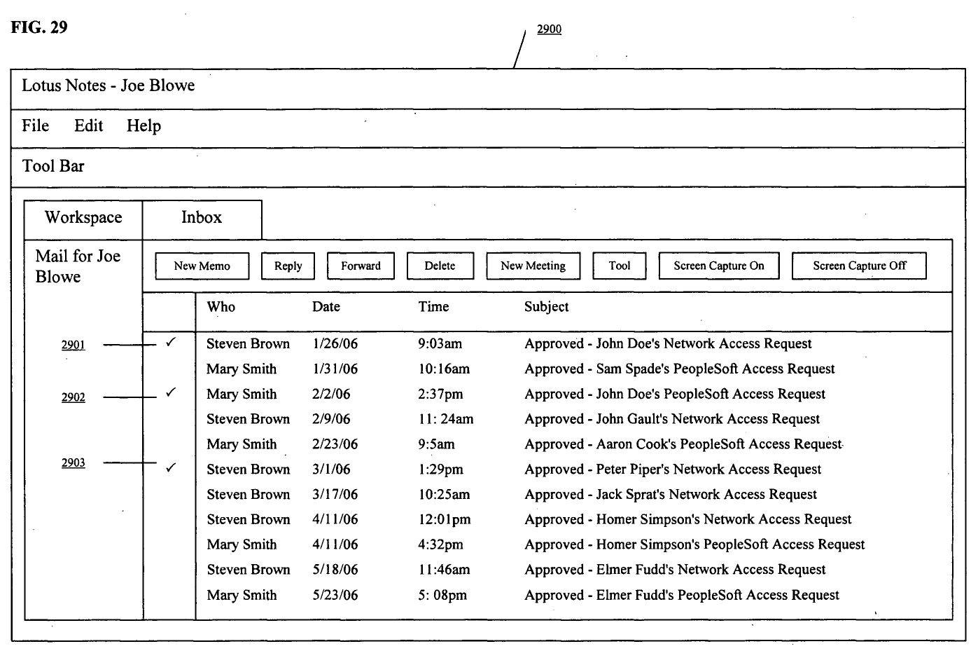

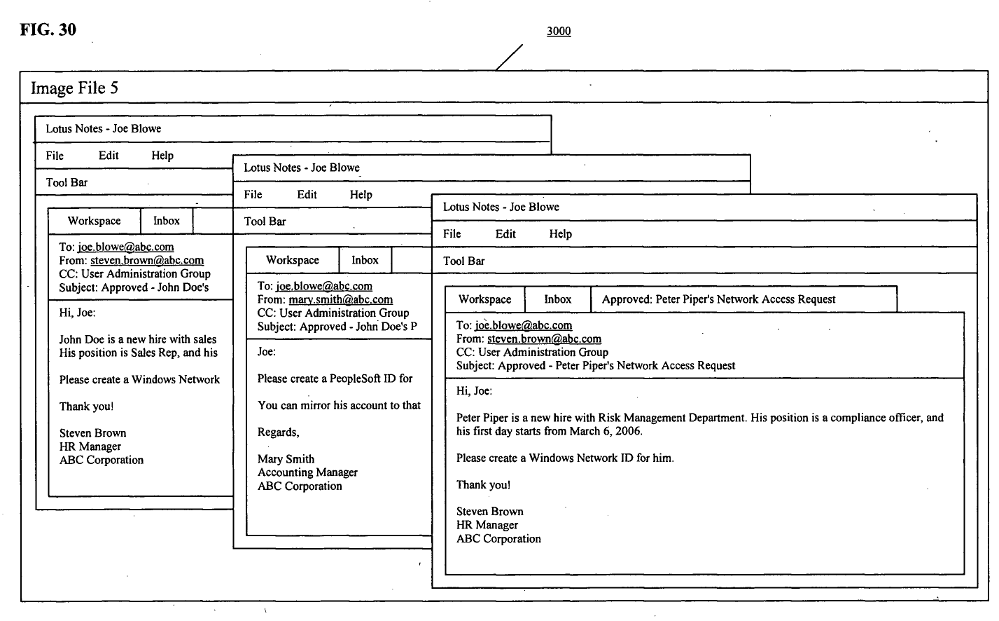

FIG. 29 and FIG. 30 are exemplary displays of user-selected items in a targeted computer application utilizing DSC to produce a plurality of screen shots of those selected items without the need for the user to manually open up and capture each targeted screen. Such items in a targeted computer application can be emails, tickets, accounts, etc.

As indicated on display 2900 of FIG. 29, herein depicted a user email account that contains multiple emails in the inbox. For simplicity sake, the user in this exemplary illustration selects three emails as shown at 2901, 2902, and 2903. He then activates DSC program, which then automatically opens up the first email, captures the displayed email and exports the image to a destination file. Those skilled in the art will appreciate that DSC could automatically scrolling the email window if some of the content is out of the display screen.

Then, DSC closes this email and opens up the second one, captures the displayed second email and exports the image to the same destination file, and then repeats the same process for the third email.

When the user opens and displays the destination file, it looks like the display 3000 of FIG. 30. It should be noted to those skilled in the art that the display of these images can be sequential and one at a time, rather than what is shown on FIG. 30, which is aimed at illustrating that all screens are captured and placed in the same destination file. Also, such images can be exported to separate destination files based on initial configurations.

We claim:

1. A computer-readable medium storing computer-executable instructions for causing a computer system programmed thereby to perform a method of capturing a plurality of designated screens of one or more targeted computer programs or computer systems, the method comprising:
capturing a plurality of designated screen images of at least one targeted computer program or computer system upon receiving keystrokes, mouse-clicks, recorded instructions or voice commands; and
exporting said plurality of captured screen images to one or more destination files.

2. The method of claim 1 further comprising:
intercepting keystrokes and/or mouse-clicks;
comparing said keystroke and/or mouse-click data to pre-defined keystroke and/or mouse-click data;
capturing said targeted screens when said user-supplied keystrokes and/or mouse-clicks match said pre-defined keystroke and/or mouse-click data for screen capturing;
converting said captured images into an intermediate format;
translating said intermediate format into an image stream that has a graphic format acceptable to said destination files; and
exporting said image stream to said destination files.

3. The method of claim 1 further comprising:
converting said captured images into an intermediate format;
processing intermediate format data to generate processed images and associated processed data;
translating said processed images into an image stream that has a graphic format acceptable to said destination files; and
exporting said processed image stream to said destination files.

4. The method of claim 1 wherein capturing a plurality of designated screen images further comprising:
allowing a user to remove captured images from said destination files via an undo action.

5. The method of claim 1 wherein capturing a plurality of designated screen images further comprising:
automatically scrolling to capture entire windows;
producing computer generated sounds when capturing said targeted screens; and
allowing a user to enable or disable designated screen capturing by turning on or turning off designated screen capturing.

6. The method of claim 1 wherein exporting said plurality of captured screen images further comprising:
assigning a file name of said destination file automatically or prompting a user to enter a file name; and
storing the image stream to said destination file via an export utility tool, and said destination file can be read or displayed by an external application or by said designated screen capturing program that runs either in the background or with a display that can be minimized.

7. The method of claim 1 further comprising:
logging user keystrokes and/or mouse-clicks in response to a user activating keystroke and/or mouse-click logging; and
replaying the sequence of said keystrokes and/or mouse-clicks in the order recorded to automatically capture a plurality of screen images of at least one targeted computer program or computer system in response to said user invoking keystroke and/or mouse-click replay.

8. The method of claim 7 wherein logging user keystrokes and/or mouse-clicks further comprising:
disabling logging in response to said user deactivating keystroke and/or mouse-click logging; and
re-enabling logging in response to said user reactivating keystroke and/or mouse-click logging.

9. The method of claim 7 wherein logging user keystrokes and/or mouse-clicks includes:
invoking said keystroke and/or mouse-click logging at a user-specified time;
automatically assigning a file name of said log file or prompting said user to enter a file name in response to said user invoking said keystroke and/or mouse-click logging; and
logging keystrokes and/or mouse-clicks when said logging is turned on, including those keystrokes and/or mouse-clicks instructions that reveal the locations of said targeted computer programs or computer systems.

10. The method of claim 7 wherein replaying said user keystrokes and/or mouse-clicks includes:
invoking said keystroke and/or mouse-click replaying via an initializing means;
selecting a keystroke and/or mouse-click log file to be replayed via a selecting means; and
simulating the entire process of capturing designated screens from launching at least one targeted computer program or computer system or with the targeted program or system in a specific state, navigating to said desired screens, capturing said screen images, converting said screen images into image streams, to exporting said image streams into said destination files.

11. The method of claim 7 wherein replaying user keystrokes and/or mouse-clicks further comprising:
converting a log file into a template by replacing specified data with tags;
generating tag value files; and
repeatedly replaying the instructions in said template with inserted tag values from said tag value files to capture targeted screens related to said tag values.

12. The method of claim 1 wherein capturing designated screen images upon receiving voice commands further comprising:
intercepting user voice commands;
digitizing said intercepted voice commands;
processing digitized voice commands to determine if said digitized voice commands match any pre-defined DSC commands;
capturing said targeted screen images when said digitized voice commands match pre-defined screen capturing commands for screen capturing; and
exporting said captured images to at least one destination file.

13. The method of claim 1 further comprising:
logging said voice commands in response to a user activating voice command logging; and
replaying the sequence of voice commands in the order recorded to automatically capture a plurality of screen images of one or more targeted computer programs or computer systems in response to a user invoking voice command replaying.

14. The method of claim 1 further comprising:
logging keystrokes, mouse-clicks and/or voice commands to a log file according to action sequence in response to a user activating keystroke, mouse-click and/or voice command logging; and
replaying the sequence of said log file that comprises keystrokes, mouse-clicks and/or voice commands in the order recorded to automatically capture a plurality of screen images of one or more targeted computer programs or computer systems in response to a user activating keystroke, mouse-click and/or voice command replaying.

15. The method of claim 1 further comprising:
automatically indexing captured images in said destination files;
assigning security attributes for said destination files; and
enabling a user to insert comments or marks in said destination files.

16. The method of claim 1 further comprising:
displaying captured images with index, security, comments, and/or marks information in said destination files;
allowing a user to modify said information within said destination files based on initial settings; and
allowing a user to modify or manipulate captured image contents based on initial settings.

17. The method of claim 16 wherein allowing a user to modify or manipulate captured image contents further comprising:
automatically displaying a label indicating said captured screen source image is not original upon such modification or manipulation.

18. The method of claim 1 further comprising:
adding designated screen capturing jobs to a batch scheduler;
submitting said designated screen capturing jobs for batch processing;
running said designated screen capturing jobs to automatically capture a plurality of targeted screens at a specified time; and
automatically exporting said screen images into at least one destination file.

19. The method of claim 1 further comprising:
modifying targeted computer programs or computer systems whose screens are to be captured to incorporate a designated screen capturing program;
capturing a plurality of entire screens of said targeted computer programs or computer systems via automatic scrolling on targeted windows; and
exporting said plurality of captured screen images to at least one destination file.

20. The method of claim 19 wherein incorporating said designated screen capturing program further comprising:
automatically capturing a plurality of targeted screen images by activating a screen capturing function within said targeted computer program;
converting said screen images into image streams that have graphic formats acceptable to said destination file; and
displaying said screen images stored in said destination file in response to a user invoking a destination file display program.

21. The method of claim 1 wherein designated screen capturing further comprising:
selecting multiple items to be captured in a targeted computer program or system;
sending instructions to said targeted computer program or system to automatically open each item without the need for a user to manually open said items;
capturing screen image of each item upon its automatic opening;
automatically scrolling windows of said opened items to capture contents outside of display region; and
exporting captured images to at least one destination file.

22. A computer system including a RAM memory configured to run application programs and for enabling designated screen capturing of at least one targeted computer program or targeted computer system, said computer system comprising:
At least one processing unit;
At least one input device connected to said processing unit;
At least one display device connected to said processing unit;
Said processing unit, responsive to instructions from a designated screen capturing application running on said computer system and programmed to:
capture a plurality of designated screen images of at least one targeted computer program or computer system in response to user supplied keystrokes, mouse-clicks, recorded instructions, and/or voice commands; and
export said plurality of captured screen images to at least one destination file.

23. The computer system of claim 22 further comprising:
means for intercepting keystrokes, mouse-clicks and/or voice commands by an intercepting module;
means for capturing said screen images by a screen capturing module;
means for exporting said captured screens to said destination file via converting said captured screens into image streams having graphic formats acceptable to one or more destination files by an image exporting module;
means for logging keystrokes, mouse clicks and/or voice commands by a logging module; and
means for replaying the sequence of keystrokes, mouse-clicks and/or voice commands in the order recorded to capture a plurality of screen images by a replaying module.

24. A computer program for continuously capturing a plurality of designated screen images of at least one targeted computer program or targeted computer system, said computer program comprises:
a recording medium;
a screen capturing module;
an image exporting module;
a keystroke, mouse-click, and/or voice command intercepting module;
means, recorded on said recording medium, for capturing a plurality of designated screen images of at least one targeted computer program or computer system in response to keystrokes, mouse-clicks, recorded instructions, and/or voice commands; and
means, recorded on said recording medium, for exporting said plurality of captured screen images to at least one destination file.

25. The computer program of claim 24 further comprising:
a keystroke, mouse-click, and/or voice command logging module;
a keystroke, mouse-click, and/or voice command replaying module;
means, recorded on said recording medium, for intercepting keystrokes, mouse-clicks and voice commands by said intercepting module;
means, recorded on said recording medium, for capturing said screen images by said screen capturing module;
means, recorded on said recording medium, for exporting said screen images to said destination file via converting said screen images into image streams having a graphic format acceptable to said destination file by said image exporting module;
means, recorded on said recording medium, for logging keystrokes, mouse clicks and/or voice commands by said logging module; and
means, recorded on said recording medium, for replaying the sequence of the keystrokes, mouse-clicks and/or voice commands in the order recorded to capture a plurality of screen images by said replaying module.
